(19) United States
(12) Patent Application Publication
(10) Pub. No.: US 2024/0330632 A1
(43) Pub. Date: Oct. 3, 2024

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: NAOKO BABA, Kanagawa (JP); YUKI OMAGARI, Tokyo (JP); SEIJI ABE, Kanagawa (JP); DAISUKE YOSHITOKU, Kanagawa (JP)

(21) Appl. No.: 18/620,860

(22) Filed: Mar. 28, 2024

(30) Foreign Application Priority Data
Apr. 3, 2023 (JP) 2023-060489
Mar. 14, 2024 (JP) 2024-040551

(51) Int. Cl. G06K 15/02

(52) U.S. Cl. CPC G06K 15/1878; G06K 15/027; G06K 2215/101

(57) ABSTRACT

In an image processing apparatus, in a case where an input recording mode is a first recording mode and a density characteristic value for a patch pattern in an input gradation value greater than or equal to a predetermined gradation is higher than the target density value associated with an input gradation value, in correction processing, a correction value for an input gradation value greater than or equal to the predetermined gradation is not 0, in a case where the input recording mode is a second recording mode and a density characteristic value for a patch pattern in an input gradation value greater than or equal to the predetermined gradation is higher than the target density value associated with an input gradation value, in the correction processing, a correction value for an input gradation value greater than or equal to the predetermined gradation is 0.

### BACKGROUND

### Field

The present disclosure generally relates to an image processing apparatus, an image processing method, and a storage medium each of which is configured to record an image on a recording medium.

### Description of the Related Art

There are conventional recording apparatuses each of which, as an output apparatus for recording an image on a recording medium such as recording paper, applies a recording agent to record an image. Such conventional recording apparatuses include a known inkjet recording apparatus which records an image by applying ink from a recording head including a plurality of recording elements.

Such an inkjet recording apparatus may produce a difference in recording property caused by a manufacturing error or an individual difference of recording heads. Due to this difference in recording property, an image desired by the user may not be obtained. For example, in the case of a recording head which discharges ink droplets from nozzles, density differences may occur in an image for recording due to a difference in discharge characteristic for every recording head or for every nozzle. The difference in recording property occurs due to not only a manufacturing error but also a variation in recording property of each recording element caused by aging or a variation in viscosity of ink ascribable to a usage environment. With respect to such a difference in recording property, there is known a technique which adjusts color tone of an image by performing color misregistration correction processing which is called “color calibration”.

Japanese Patent Application Laid-Open No. 2004-167947 discusses a technique which records image data for color calibration representing sample images for a plurality of gradations for each ink color and calculates a density correction value for each gradation of each ink color based on a result of recording of the sample images.

### SUMMARY

According to some embodiments, an image processing apparatus includes an input unit configured to receive an instruction indicating which recording mode of a plurality of recording modes to use to record an image, a correction unit configured to perform correction processing for image data including pixel values for use in applying ink onto a recording medium with a recording unit, an acquisition unit configured to acquire a density characteristic value by measuring a patch pattern recorded by the recording unit, and a retention unit configured to retain a target density value associated with an input gradation value, wherein, in a case where the recording mode indicated by the received instruction is a first recording mode and a density characteristic value for a patch pattern in an input gradation value greater than or equal to a predetermined gradation is higher than the target density value associated with an input gradation value, in the correction processing, a correction value for an input gradation value greater than or equal to the predetermined gradation is not 0, and wherein, in a case where the recording mode indicated by the received instruction is a second recording mode and a density characteristic value for a patch pattern in an input gradation value greater than or equal to the predetermined gradation is higher than the target density value associated with an input gradation value, in the correction processing, a correction value for an input gradation value greater than or equal to the predetermined gradation is 0.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of a recording system.

FIG. 2 is a perspective diagram of a recording apparatus.

FIG. 3 is a diagram illustrating a recording head.

FIGS. 4A and 4B are diagrams illustrating an outline configuration of a multipurpose sensor.

FIG. 5 is an explanatory diagram of a control circuit which processes input and output signals of the multipurpose sensor.

FIGS. 6A and 6B are in combination a diagram used to explain the flow of image processing.

FIG. 7 is a diagram illustrating a patch pattern for use in density characteristic value acquisition processing.

FIG. 8 is a flowchart illustrating density characteristic value acquisition processing.

FIGS. 9A, 9B, 9C, 9D, and 9E are diagrams used to explain a generation method for a color misregistration correction table.

FIG. 10 is a diagram illustrating a recording mode information table.

FIG. 11 is a flowchart of black (K) region determination processing.

FIGS. 12A, 12B, 12C, and 12D are diagrams used to explain bold processing in the K region determination processing.

FIGS. 13A and 13B are diagrams illustrating an example of a result of the K region determination processing.

FIGS. 14A and 14B are diagrams used to explain a thinning mask and a dot arrangement of K distribution thinning processing.

FIGS. 15A and 15B are diagrams used to explain a thinning mask and a dot arrangement of K distribution thinning processing.

FIG. 16 is a diagram illustrating an output upper limit rank table used to explain output upper limit ranks.

FIG. 17 is a flowchart for color misregistration correction table generation associated with output upper limit ranks.

FIG. 18 is a diagram used to explain a recording density value conversion method for modes different in the maximum applying amount.

FIG. 19 is a diagram used to explain the number of dots associated with gradation levels.

FIG. 20 is a diagram used to explain an input count value conversion method.

FIGS. 21A and 21B are diagrams used to explain the number of dots for a thin line.

FIGS. 22A, 22B, 22C, and 22D are diagrams used to explain color misregistration correction table generation in the case of not correcting the maximum applying amount.

FIGS. 23A and 23B are diagrams illustrating a selection method for a color misregistration correction table in a case where there is no number-of-applications surplus.

FIGS. 24A and 24B are diagrams illustrating a selection method for a color misregistration correction table in a case where there is a number-of-applications surplus.

FIG. 25 is a flowchart for selecting a color misregistration correction table type.

### DESCRIPTION OF THE EMBODIMENTS

Various exemplary embodiments, features, and aspects of the disclosure will be described in detail below with reference to the drawings.

The following exemplary embodiments are not intended to limit the present disclosure matters, and not all of the combinations of features described in the exemplary embodiments are essential for solutions in the present disclosure. Furthermore, the same constituent elements are assigned the respective same reference numerals or characters and any duplicated description thereof is omitted.

### <Recording System Configuration>

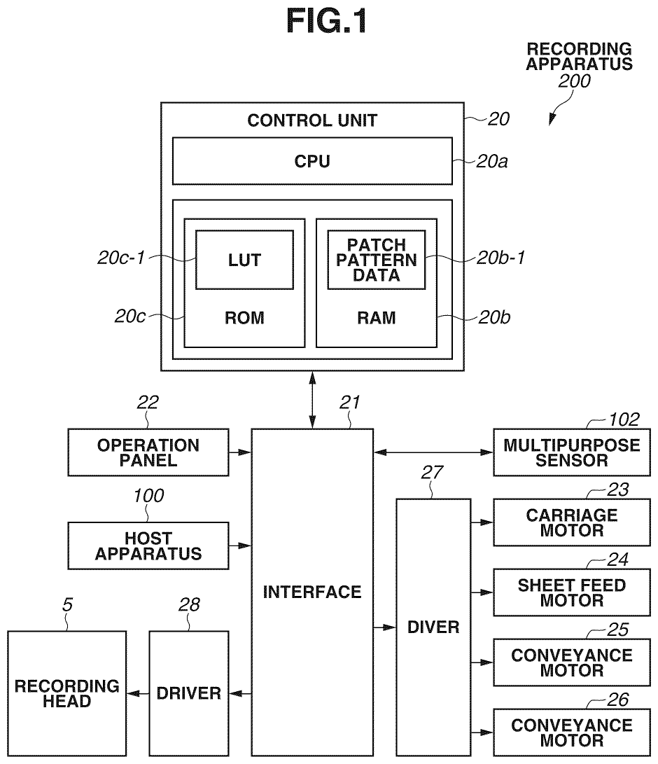

FIG. 1 is a block diagram illustrating a configuration of a recording system according to the present exemplary embodiment. The recording system according to the present exemplary embodiment includes a host apparatus 100 and a recording apparatus 200. The host apparatus 100 is an information processing apparatus, such as a personal computer, which is configured to be connected to the recording apparatus 200. The recording apparatus 200 is an inkjet recording apparatus which records an image on a recording medium by applying ink droplets onto the recording medium, and includes a recording head 5, a control unit 20, a carriage motor 23, a sheet feed motor 24, a conveyance motor 25, and a conveyance motor 26.

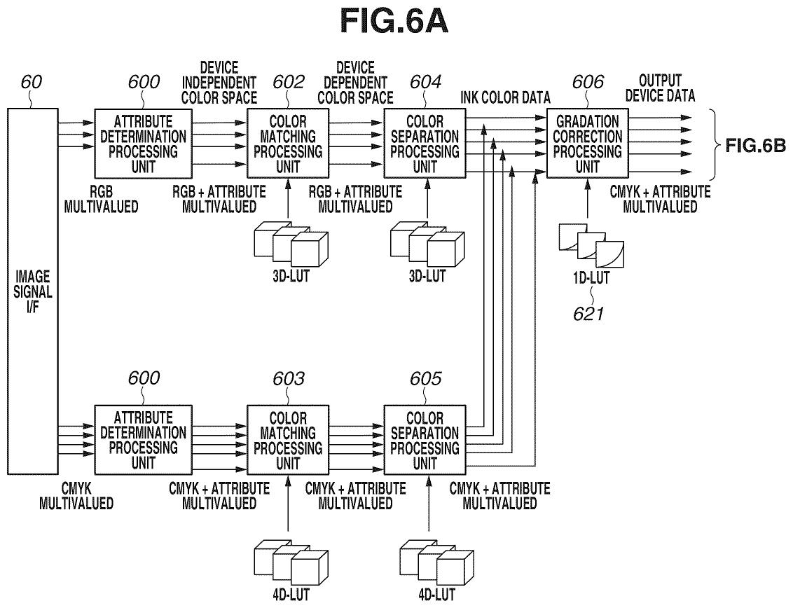

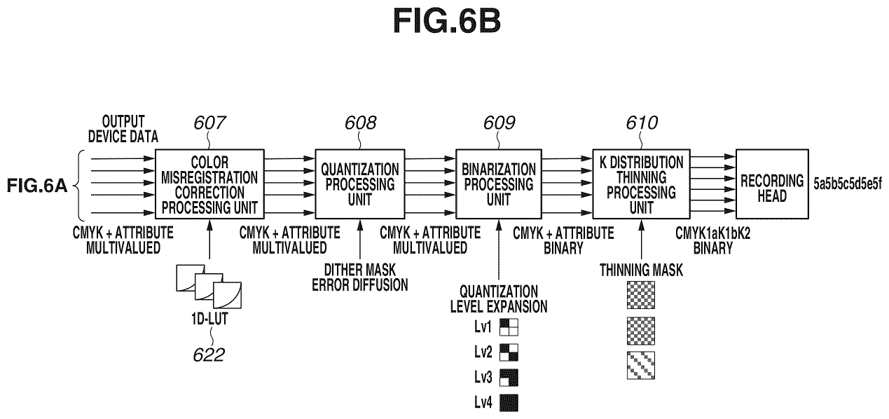

The control unit 20 includes a central processing unit (CPU) 20a with one or more processors, microprocessors, circuitry, or combinations thereof, and a read-only memory (ROM) 20c, a random access memory (RAM) 20b, or other memories. The ROM 20c stores control programs for the CPU 20a and various pieces of data such as parameters for a recording operation. The RAM 20b is used as a work area for the CPU 20a and performs temporary storing of various pieces of data such as image data received from the host apparatus 100 or image data generated by the recording apparatus 200. The ROM 20c has a look-up table (LUT) 20c-1 stored therein. The LUT 20c-1 is described below with reference to FIGS. 6A and 6B. The RAM 20b has patch pattern data 20b-1, which is used to record a patch pattern, stored therein.

Furthermore, the LUT 20c-1 can be stored in the RAM 20b, and the patch pattern data 20b-1 can be stored in the ROM 20c.

The control unit 20 performs processing for inputting and outputting data such as image data and parameters for use in recording with respect to the host apparatus 100 via an interface 21, or performs processing for receiving and inputting various pieces of information, such as a character pitch, a character type, and a recording mode, from an operation panel 22. The control unit 20 outputs, via the interface 21, ON or OFF signals for driving respective motors such as the sheet feed motor 24 and the conveyance motor 25. Additionally, the control unit 20 outputs, for example, a discharge signal to a driver 28, thus controlling a discharge operation for ink droplets of the recording head 5, which is mounted on a carriage unit 2.

Such a control system includes the interface 21, the operation panel 22, a multipurpose sensor 102, and drivers 27 and 28. The driver 27 drives a carriage motor 23, which is configured to drive the carriage unit 2, and the sheet feed motor 24, which is configured to drive a feed roller, according to an instruction issued from the CPU 20a. Moreover, the driver 27 drives the conveyance motor 25 for driving a first conveyance roller pair and the conveyance motor 26 for driving a second conveyance roller pair, according to an instruction issued from the CPU 20a. The driver 28 drives the recording head 5.

### <Configuration of Recording Apparatus and Outline of Recording Operation>

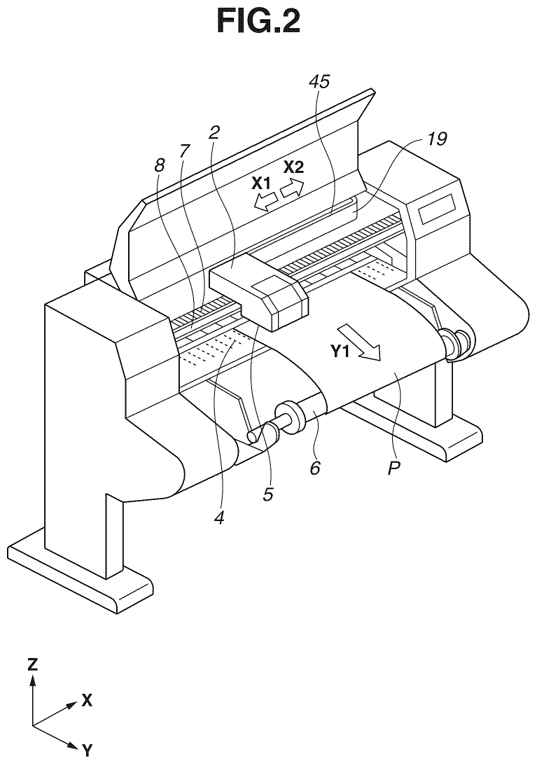

FIG. 2 is a perspective view of the recording apparatus 200. A configuration of the recording apparatus 200 and an operation for recording performed by the recording apparatus 200 are described with reference to FIG. 2.

A sheet feed roller and a conveyance roller (both not illustrated) are driven by the sheet feed motor 24 and the conveyance motor 25 via gears. This driving causes a recording medium P, which is held in the roll-shaped manner, to be conveyed in the direction of arrow Y (Y-direction) illustrated in FIG. 2. The Y-direction in FIG. 2 is also referred to as a “conveyance direction”. The carriage unit 2, which is driven by the carriage motor 23, is able to perform reciprocating scanning (reciprocating movement) along a guide shaft 8, which extends in the direction of arrow X (X-direction) illustrated in FIG. 2. The direction of arrow X1 (X1-direction) illustrated in FIG. 2 is assumed to be a forward scanning direction, and the direction of arrow X2 (X2-direction) illustrated in FIG. 2 is assumed to be a backward scanning direction. While the carriage unit 2 performs scanning once, ink is discharged as droplets from the recording head 5 at timing that is based on a position signal obtained by an encoder 7. The recording head 5 has a plurality of nozzles arrayed therein. Then, scanning once performed by the carriage unit 2 enables recording an image in a region with a width (nozzle width) corresponding to the length of the plurality of nozzles arrayed in the Y-direction. The region in which an image is recorded by the recording head 5 of the recording medium P is supported from below by a platen 4.

Repetition of scanning performed once by the carriage unit 2 and conveyance of the recording medium P performed by the conveyance motor 25 causes an image to be recorded on the recording medium. In the case of what is called n-pass recording, in which scanning performed n times (n being a natural number) for recording scanning causes an image to be recorded in a unit region on the recording medium, after scanning performed once by the carriage unit 2, a conveyance operation for the recording medium with an amount of 1/n of the nozzle width available for recording with scanning performed once is performed. Alternately repeating such a recording scanning and conveyance operation causes recording of an image to be completed.

The carriage unit 2 has the multipurpose sensor 102 mounted therein. The multipurpose sensor 102 performs, for example, detection of the density of an image recorded on the recording medium P, detection of the width of the recording medium P in the X1-direction), and detection of the distance from the recording head 5 to the recording medium P.

While a carriage belt is used for transmission of driving force from the carriage motor 23 to the carriage unit 2, the method for transmission of driving force is not limited to the carriage belt. Instead of the carriage belt, another driving method such as a configuration including a lead screw which is driven for rotation by a carriage motor and extends in the X1-direction and an engagement portion which is provided at the carriage unit 2 and engages with a groove of the lead screw can be used.

Moreover, in a pause state, in which recording of an image is not being performed, a face surface with a plurality of nozzles of the recording head 5 provided thereon is sealed by a cap. In response to an instruction for recording being received, the cap is opened and the carriage unit 2 with the recording head mounted thereon becomes ready to perform scanning. Then, when data for recording scanning to be performed once is accumulated in a buffer, the above-mentioned scanning recording and conveyance operation are performed.

### <Recording Head 5>

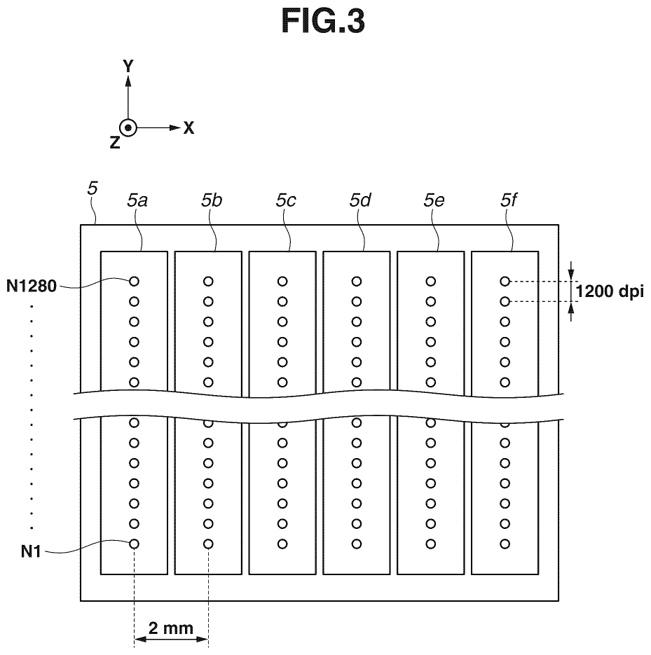

FIG. 3 is a front view of the recording head 5 as viewed from the face surface with a plurality of nozzles provided thereon. On the recording head 5, six rows, i.e., nozzle rows 5a to 5f, are provided in the X-direction in FIG. 3. In each nozzle row, 1,280 nozzles N1 to N1280 are arrayed at intervals of 1,200 dots per inch (dpi) in the Y-direction. Inside each nozzle, a recording element which generates energy for discharging ink is provided. While the recording head 5 in the present exemplary embodiment is what is called a thermal-type recording head, in which an electro-thermal conversion element for converting electric energy into thermal energy is used as the recording element, the present exemplary embodiment is not limited to this discharging method. A piezoelectric element can be used as the recording element. The central distance in the X-direction between the nozzle row 5a and the nozzle row 5b is 2 millimeters (mm). Each of the central distance between the nozzle row 5b and the nozzle row 5c, the central distance between the nozzle row 5c and the nozzle row 5d, the central distance between the nozzle row 5d and the nozzle row 5e, and the central distance between the nozzle row 5e and the nozzle row 5f is similarly 2 mm in the X-direction.

Ink of cyan (C) is supplied to each nozzle of the nozzle row 5a, ink of magenta (M) is supplied to each nozzle of the nozzle row 5b, and ink of yellow (Y) is supplied to each nozzle of the nozzle row 5c. Ink of low-permeation black (K1) is supplied to each nozzle of the nozzle row 5d and the nozzle row 5f, and ink of high-permeation black (K2) is supplied to each nozzle of the nozzle row 5e. The high-permeation black ink (K2) and the low-permeation black ink (K1) are achromatic inks of similar colors having an approximately identical hue, and the low-permeation black ink (K1) has a larger surface tension than that of the high-permeation black ink (K2).

Furthermore, the number of nozzles and the number of nozzle rows are not limited to the respective numeral values in the above-mentioned example, and the types of inks and the number of types of inks are not limited to those of the above-mentioned types.

### <Details of Multipurpose Sensor>

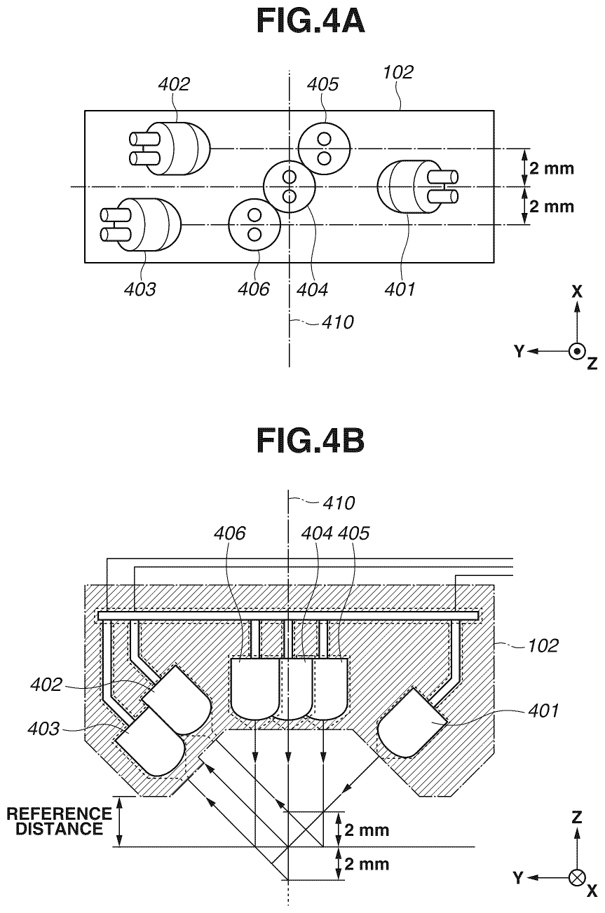

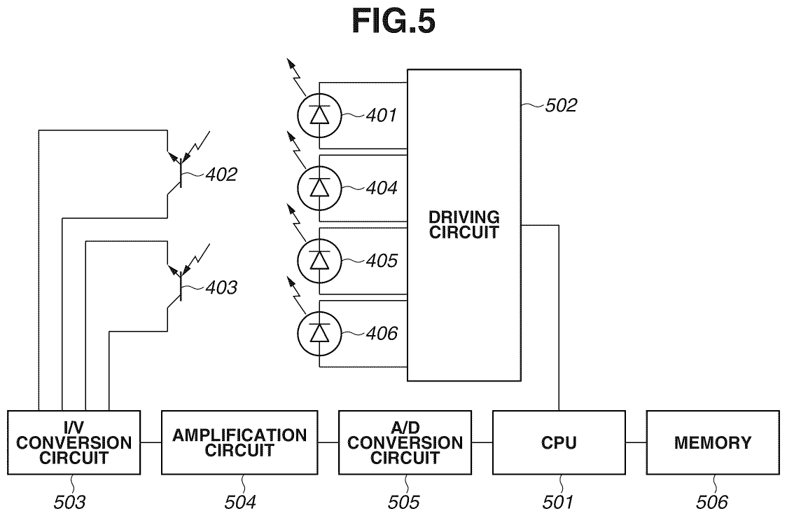

Details of the multipurpose sensor 102 are described with reference to FIGS. 4A and 4B and FIG. 5. FIGS. 4A and 4B are schematic configuration diagrams of the multipurpose sensor 102, in which FIG. 4A is a plan view of the multipurpose sensor 102 as viewed from a direction perpendicular to the X-Y plane and FIG. 4B is a see-through view of the multipurpose sensor 102 as viewed in the X-direction.

The measurement region of the multipurpose sensor 102 is provided on the downstream side in the Y-direction of the recording head 5 and the lower surface of the multipurpose sensor 102 is provided at the same position as that of the face surface of the recording head 5 or at the position higher than such the same position (above such the same position). The multipurpose sensor 102 includes phototransistors 402 and 403 serving as two optical elements, three visible light-emitting diodes (LEDs) 404, 405, and 406, and one infrared LED 401. Driving of each element is performed by an external circuit (not illustrated). Each of these elements is a shell-type element with a diameter of about 4 mm at the largest portion thereof, and has a general size of 3.0 mm to 3.1 mm in diameter φ.

Furthermore, in the present exemplary embodiment, a straight line connecting the center point of an irradiation range of irradiation light radiated from a light-emitting element to a measuring surface and the center of the light-emitting element is referred to as an “optical axis of the light-emitting element” or an “irradiation axis of the light-emitting element”. The irradiation axis is also the center of a light flux of irradiation light.

The infrared LED 401 has an irradiation angle of 45 degrees to the surface (measuring surface) of the recording medium P, which is parallel to the X-Y plane. Then, the irradiation axis, which is the center of irradiation light, of the infrared LED 401 is arranged in such a way as to intersect with a sensor center axis 410 parallel to the normal (Z-axis) of the measuring surface at a predetermined position. A position on the Z-axis of such a position for intersection (intersection point) is set as a reference position, and a distance from the sensor to the reference position is set as a reference distance. The irradiation light of the infrared LED 401 is optimized in such a manner that the width of irradiation light is adjusted by an opening portion and an irradiation surface (irradiation region) with a diameter of about 4 mm to 5 mm is formed on the measuring surface, which is located at the reference position.

Each of the two phototransistors 402 and 403 has a sensitivity for light of wavelengths of visible light to infrared light. When the measuring surface is located at the reference position, the phototransistors 402 and 403 are arranged in such a manner that the light receiving axis of each of the phototransistors 402 and 403 becomes parallel to the reflection axis of the infrared LED 401. Thus, the light receiving axis of the phototransistor 402 is arranged in such a way as to be located at a position shifted by +2 mm in the X-direction and shifted by +2 mm in the Z-direction with respect to the reflection axis of the infrared LED 401. Moreover, the light receiving axis of the phototransistor 403 is arranged in such a way as to be located at a position shifted by −2 mm in the X-direction and shifted by −2 mm in the Z-direction with respect to the reflection axis of the infrared LED 401. When the measuring surface is located at the reference position, the intersection point of the irradiation axes of the infrared LED 401 and the visible LED 404 is located on the measuring surface, and the respective light receiving regions of the two phototransistors 402 and 403 at such a position are formed in such a way as to surround the intersection point. A spacer with a thickness of about 1 mm is inserted into between two elements, so that a structure which prevents respective light fluxes received by the two elements from intruding into each other is formed. An opening portion for limiting a light incident region is also provided at the side of each phototransistor, and the size of the opening portion is optimized in such a way as to become able to receive only reflection light in the range of 3 mm to 4 mm in diameter of the measuring surface located at the reference position.

Furthermore, in the present exemplary embodiment, a line connecting the center point of a region (range) available for light reception by the light receiving element in the measuring surface (measuring target surface) and the center of the light receiving element is referred to as an “optical axis of the light receiving element” or a “light receiving axis of the light receiving element”. The light receiving axis is also the center of a light flux of reflection light, which is reflected at the measuring surface and is then received by the light receiving element.

In FIGS. 4A and 4B, the visible LED 404 is a single-color visible LED having green light emission wavelengths (about 510 nanometers (nm) to 530 nm), and is arranged in such a way as to coincide with the sensor center axis 410. Moreover, the visible LED 405 is a single-color visible LED having blue light emission wavelengths (about 460 nm to 480 nm), and is arranged at a position shifter by +2 mm in the X-direction and shifted by −2 mm in the Y-direction with respect to the visible LED 404 as illustrated in FIG. 4A. Then, when the measuring surface is located at the reference position, the visible LED 405 is arranged in such a manner that the irradiation axis of the visible LED 405 and the light receiving axis of the phototransistor 402 intersect with each other at the measuring surface. Additionally, the visible LED 406 is a single-color visible LED having red light emission wavelengths (about 620 nm to 640 nm), and is arranged at a position shifter by −2 mm in the X-direction and shifted by +2 mm in the Y-direction with respect to the visible LED 404 as illustrated in FIG. 4A. Then, when the measuring surface is located at the reference position, the visible LED 406 is arranged in such a manner that the irradiation axis of the visible LED 406 and the light receiving axis of the phototransistor 403 intersect with each other at the measuring surface.

FIG. 5 is a schematic diagram of a control circuit which processes signals input to and output from the respective sensors of the multipurpose sensor 102. A central processing unit (CPU) 501 performs, for example, outputting of ON or OFF control signals for the infrared LED 401 and the visible LEDs 404, 405, and 406 and calculation operations of output signals obtained according to the amounts of light received by the phototransistors 402 and 403. A driving circuit 502 receives ON signals sent from the CPU 501 and supplies constant currents to the respective light-emitting elements to cause the light-emitting elements to perform light emission, and adjusts the amounts of light emission of the respective light-emitting elements in such a manner that the amounts of light received by the respective light receiving elements become predetermined amounts. A current-to-voltage (I/V) conversion circuit 503 converts output signals sent and coming as current values from the phototransistors 402 and 403 into voltage values. An amplification circuit 504 amplifies an output signal converted into a voltage value, which is a minute signal, to a level optimum for analog-to-digital (A/D) conversion. An A/D conversion circuit 505 converts an output signal amplified by the amplification circuit 504 into a 10-bit digital signal and inputs the 10-bit digital signal to the CPU 501. A memory 506 is, for example, a non-volatile memory, and is used for storage of reference data for deriving desired measured values from calculation results obtained by the CPU 501 and temporary storage of output values. Furthermore, the CPU 20a or the RAM 20b included in the recording apparatus 200 can be used as the CPU 501 or the memory 506.

### <Ink Formulation>

Next, the composition of each of inks which are used in the present exemplary embodiment is described. In the following description, the terms “part” and “percent” are, unless otherwise noted, based on mass.

### Preparation of High-Permeation Black Ink (K2)

### (1) Preparation of Dispersion Liquid

First, an anionic polymer P-1 [styrene-butylacrylate-acrylic acid copolymer (a copolymerization ratio (ratio by weight) of 30/40/30, an acid value of 202, a weight-average molecular mass of 6500)] is provided. This is neutralized with a potassium hydroxide solution and diluted with ion-exchanged water, so that 10 mass percent of a homogeneous polymer solution is prepared.

Then, the above-mentioned polymer solution (600 g), carbon black (100 g), and ion-exchanged water (300 g) are mixed and mechanically agitated for a predetermined time, and, then, the mixture is subjected to centrifugal separation processing, so that undispersed material including coarse particles is removed and, thus, a black dispersion liquid is obtained. The obtained black dispersion liquid had a pigment concentration of 10 mass percent.

### (2) Preparation of Ink

The above-mentioned black dispersion liquid is used for preparation of ink. The following ingredients are added to the above-mentioned black dispersion liquid, and the black dispersion liquid with the ingredients added thereto is sufficiently mixed and agitated, and is then filtered under pressure through a microfilter (manufactured by Fujifilm Corporation) having a pore size of 2.5 micrometers (μm), so that a pigment ink having a pigment concentration of 5 mass percent is prepared. In this way, the high-permeation black ink (K2) for use in the present exemplary embodiment was prepared: the above-mentioned black dispersion liquid 50 parts,

| | |
|---|---|
| glycerin | 10 parts, |
| triethylene glycol | 10 parts, |
| acetylene glycol EO adduct (manufactured | 1.0 parts, and |
| by Kawaken Fine Chemicals Co., Ltd.) | |
| ion-exchanged water | the remaining parts. |

### Preparation of Low-permeation Black Ink (K1)

The above-mentioned black dispersion liquid prepared for high-permeation black ink is used. The following ingredients are added to the above-mentioned black dispersion liquid, and the black dispersion liquid with the ingredients added thereto is sufficiently mixed and agitated, and is then filtered under pressure through a microfilter (manufactured by Fujifilm Corporation) having a pore size of 2.5 μm, so that a pigment ink having a pigment concentration of 3 mass percent is prepared. In this way, the low-permeation black ink (K1) for use in the present exemplary embodiment was prepared: the above-mentioned black dispersion liquid 30 parts,

| | | |
|---|---|---|
| glycerin | 10 | parts, |
| triethylene glycol | 10 | parts, |
| 2-pyrolidon | 5 | parts, |

| | |
|---|---|
| acetylene glycol EO adduct (manufactured | 0.1 parts, and |
| by Kawaken Fine Chemicals Co., Ltd.) | |
| ion-exchanged water | the remaining parts. |

### Preparation of Cyan Ink (C)

### (1) Preparation of Dispersion Ink

First, with use of benzyl acrylate and methacrylic acid as raw materials, an AB block polymer having an acid value of 250 and a number-average molecular mass of 3000 is produced in the usual manner, and, then, the AB block polymer is neutralized with a potassium hydroxide solution and diluted with ion-exchanged water, so that 50 mass percent of a homogeneous polymer solution is prepared.

The above-mentioned polymer solution (200 g), C.I. Pigment Blue 15:3 (100 g), and ion-exchanged water (700 g) are mixed and mechanically agitated for a predetermined time, and, then, the mixture is subjected to centrifugal separation processing, so that undispersed material including coarse particles is removed and, thus, a cyan dispersion liquid is obtained. The obtained cyan dispersion liquid had a pigment concentration of 10 mass percent.

### (2) Preparation of Ink

The above-mentioned cyan dispersion liquid is used for preparation of ink. The following ingredients are added to the above-mentioned cyan dispersion liquid, and the cyan dispersion liquid with the ingredients added thereto is sufficiently mixed and agitated, and is then filtered under pressure through a microfilter (manufactured by Fujifilm Corporation) having a pore size of 2.5 μm, so that a pigment ink having a pigment concentration of 2 mass percent is prepared. In this way, the cyan ink for use in the present exemplary embodiment was prepared:
the above-mentioned black dispersion liquid 20 parts,

| | | |
|---|---|---|
| glycerin | 10 | parts, |
| diethylene glycol | 10 | parts, |
| 2-pyrolidon | 5 | parts, |

| | |
|---|---|
| acetylene glycol EO adduct (manufactured | 1.0 parts, and |
| by Kawaken Fine Chemicals Co., Ltd.) | |
| ion-exchanged water | the remaining parts. |

### Preparation of Magenta Ink (M)

### (1) Preparation of Dispersion Ink

First, with use of benzyl acrylate and methacrylic acid as raw materials, an AB block polymer having an acid value of 300 and a number-average molecular mass of 2500 is produced in the usual manner, and, then, the AB block polymer is neutralized with a potassium hydroxide solution and diluted with ion-exchanged water, so that 50 mass percent of a homogeneous polymer solution is prepared.

The above-mentioned polymer solution (100 g), C.I. Pigment Red 122 (100 g), and ion-exchanged water (800 g) are mixed and mechanically agitated for a predetermined time, and, then, the mixture is subjected to centrifugal separation processing, so that undispersed material including coarse particles is removed and, thus, a magenta dispersion liquid is obtained. The obtained magenta dispersion liquid had a pigment concentration of 10 mass percent.

### (2) Preparation of Ink

The above-mentioned magenta dispersion liquid is used for preparation of ink. The following ingredients are added to the above-mentioned magenta dispersion liquid, and the magenta dispersion liquid with the ingredients added thereto is sufficiently mixed and agitated, and is then filtered under pressure through a microfilter (manufactured by Fujifilm Corporation) having a pore size of 2.5 μm, so that a pigment ink having a pigment concentration of 4 mass percent is prepared. In this way, the magenta ink for use in the present exemplary embodiment was prepared:
the above-mentioned black dispersion liquid 40 parts,

| | | |
|---|---|---|
| glycerin | 10 | parts, |
| diethylene glycol | 10 | parts, |
| 2-pyrolidon | 5 | parts, |

| | |
|---|---|
| acetylene glycol EO adduct (manufactured | 1.0 parts, and |
| by Kawaken Fine Chemicals Co., Ltd.) | |
| ion-exchanged water | the remaining parts. |

### Preparation of Yellow Ink (Y)

### (1) Preparation of Dispersion Ink

First, the above-mentioned anionic polymer P-1 is neutralized with a potassium hydroxide solution and diluted with ion-exchanged water, so that 10 mass percent of a homogeneous polymer solution is prepared.

The above-mentioned polymer solution (300 g), C.I. Pigment yellow 74 (100 g), and ion-exchanged water (600 g) are mixed and mechanically agitated for a predetermined time, and, then, the mixture is subjected to centrifugal separation processing, so that undispersed material including coarse particles is removed and, thus, a yellow dispersion liquid is obtained. The obtained yellow dispersion liquid had a pigment concentration of 10 mass percent.

### (2) Preparation of Ink

The following ingredients are mixed to the above-mentioned yellow dispersion liquid, and the yellow dispersion liquid with the ingredients mixed thereto is sufficiently agitated, dissolved, and dispersed, and is then filtered under pressure through a microfilter (manufactured by Fujifilm Corporation) having a pore size of 1.0 μm, so that a pigment ink having a pigment concentration of 4 mass percent is prepared. In this way, the yellow ink for use in the present exemplary embodiment was prepared:
the above-mentioned black dispersion liquid 40 parts,

| | | |
|---|---|---|
| glycerin | 9 | parts, |
| ethylene glycol | 10 | parts, |
| 2-pyrolidon | 5 | parts, |

| | |
|---|---|
| acetylene glycol EO adduct (manufactured | 1.0 parts, and |
| by Kawaken Fine Chemicals Co., Ltd.) | |
| ion-exchanged water | the remaining parts. |

### <Surface Tension of Ink>

Each of the above-mentioned inks is prepared in such a manner that the surface tension of the low-permeation black ink (K1) becomes higher than the surface tension of each of the high-permeation black ink (K2), cyan ink (C), magenta ink (M), and yellow ink (Y). At this time, the above-mentioned magnitude relationship is satisfied with respect to both static surface tension and dynamic surface tension.

The static surface tension is measured, for example, by an automatic surface tensiometer CBVP-Z (manufactured by Kyowa Interface Science Co., Ltd.) with the temperature of ink previously adjusted to 25° C.

On the other hand, the dynamic surface tension is able to be measured by employing a maximum bubble pressure method which forms air bubbles inside a liquid and measures a change of pressure in the liquid. The measuring device to be used can be, for example, a Bubble Pressure Tensiometer BP-2 (manufactured by KRUSS Co.). Moreover, generally, as the interface formation time (an elapsed time from the instant when ink droplets are landed on a recording medium) elapses, the dynamic surface tension gradually becomes lower and then becomes stable at the value of the static surface tension. In the present exemplary embodiment, the dynamic surface tension obtained when, in a case where the recording medium was plain paper, the temperature of ink was 25° C. and the interface formation time was 10 millisecond (msec) was measured.

The result of measurements of the static surface tension and dynamic surface tension of each of the above-mentioned color inks is shown in Table 1.

TABLE 1

| | static surface tension | dynamic surface tension |
|---|---|---|
| | [mN/m] | [mN/m] |
| cyan ink (C) | 28.5 | 37.9 |
| magenta ink (M) | 28.3 | 37.5 |
| yellow ink (Y) | 28.6 | 37.3 |
| high-permeation black | 28.8 | 38.0 |
| ink (K2) | | |
| low-permeation black | 39.4 | 60.8 |
| ink (K1) | | |

mN/m: millinewton per meter

As shown in Table 1, it is understood that, with regard to each color ink for use in the present exemplary embodiment, the low-permeation black ink is higher in both static surface tension and dynamic surface tension than the other color inks.

### <Image Processing>

FIGS. 6A and 6B are in combination a diagram used to explain the flow of image processing. In the present exemplary embodiment, FIGS. 6A and 6B illustrate an image processing apparatus having the function of an RGB printer for red (R), green (G), and blue (B) (RGB) signals and the function of a CMYK printer for cyan (C), magenta (M), yellow (Y), and black (K) (CMYK) signal inputs. Moreover, while, in the present exemplary embodiment, image data is assumed to be processed as a signal value of 8 bits for each color, the number of bits is not limited to this. An image signal interface (I/F) 60 is an I/F unit for input image data, to which image data for multivalued RGB signals or image data for multivalued CMYK signals is input.

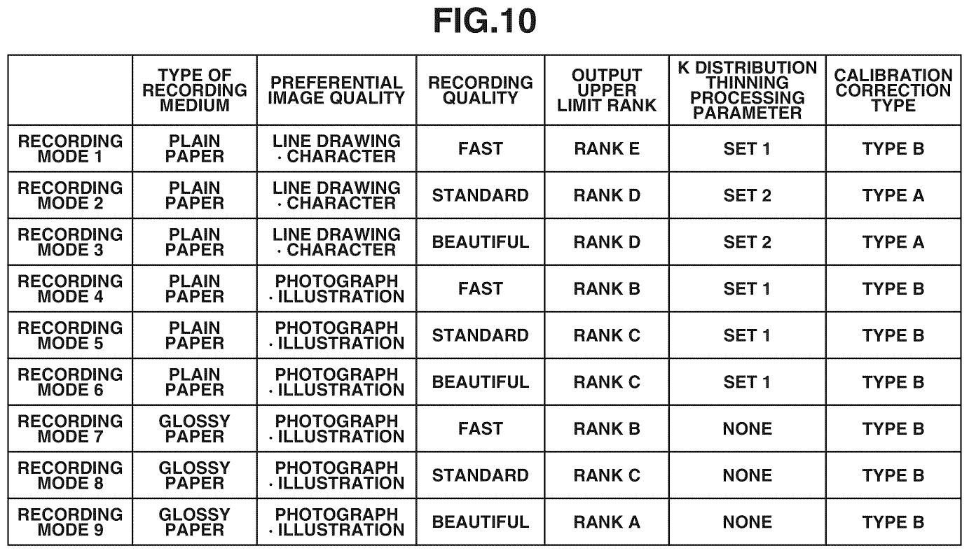

Moreover, recording mode information as well as image data is input to the image signal I/F 60. FIG. 10 illustrates a recording mode information table showing recording mode information, which is preliminarily stored in the memory (ROM) 20c of the recording apparatus 200.

The recording mode information table retains a plurality of types of information about, for example, types of recording media, preferential image qualities, recording qualities, pieces of output upper limit rank information, and calibration correction types for the respective recording modes. The output upper limit rank information and the calibration correction types are described below.

When the user issues an instruction for recording of an image to the recording apparatus 200, a type of recording medium, a preferential image quality, and a recording quality are set by the user. These pieces of information are used to determine in which of the recording modes 1 to 9 shown in the recording mode information table illustrated in FIG. 10 to perform recording. Furthermore, parameters for recording modes are not limited to the examples thereof shown in the recording mode information table illustrated in FIG. 10.

First, attribute determination processing units 600 and 601 determine whether the input pixel is a pixel having been input as black based on image data input as RGB signals or CMYK signals, and thus generate attribute data. The pixel having been input as black refers to a pixel indicating jet black (pure black) in input data, and indicates a pixel of input (R, G, B)=(0, 0, 0) with regard to RGB signals and a pixel of input (C, M, Y, K)=(0, 0, 0, 255) with regard to CMYK signals. Hereinafter, a pixel having been input as black is also referred to as a “pure black pixel”. The attribute data which is generated in the present exemplary embodiment is binary data indicating whether the input pixel is a pure black pixel having the above-mentioned pixel values, but can be three or more-valued multivalued data. The attribute data which is generated here is used by a K distribution thinning processing unit 610 described below and is, therefore, input and output together with multivalued image data indicating pixel values in the subsequent image processing, but can be input directly to the K distribution thinning processing unit 610.

After that, color matching processing units 602 and 603 perform conversion processing for color data with device independent color space into color data with device dependent color space. Next, color separation processing units 604 and 605 perform color separation processing for converting color data with a device dependent space into ink color data. A gradation correction processing unit 606 performs gradation correction processing for causing ink color data to conform to output characteristics of the recording apparatus 200. The color matching processing units 602 and 603 and the color separation processing units 604 and 605 have respective dedicated look-up tables (LUTs) set therein and are, therefore, able to perform respective desired color conversions on the input image data. The look-up tables mentioned here are managed for each type of recording medium and for each recording mode having parameters for, for example, high-speed or constant-speed recording speed and image quality. In these color conversion processing operations, three-dimensional look-up tables (3D-LUTs) or four-dimensional look-up tables (4D-LUTs) are used by the color matching processing units 602 and 603 and the color separation processing units 604 and 605. In the present exemplary embodiment, 3D-LUTs with 16×16×16=4,096 grids composed of 16 grids at intervals of 17 counts for each color are used. A gradation correction table 621 composed of one-dimensional look-up tables (1D-LUTs) is used by the gradation correction processing unit 606.

A color misregistration correction processing unit 607 corrects any color misregistration caused by a variation in the amount of discharge. The amount of discharged ink per ink droplet (the amount of discharge) varies due to an individual difference and temporal change of the recording head. In the present exemplary embodiment, density characteristic value acquisition processing using a patch pattern described below is used to recognize a status of such variation and correct any color misregistration. A color misregistration correction table 622 composed of one-dimensional look-up tables is set based on density characteristic value information and target density value information which are acquired by the density characteristic value acquisition processing.

Furthermore, the gradation correction processing unit 606 and the color misregistration correction processing unit 607 can be configured to perform processing at one time without dividing the processing into respective stages. In that case, the gradation correction processing unit 606 and the color misregistration correction processing unit 607 use a 1D-LUT obtained by combining the gradation correction table 621 and the color misregistration correction table 622.

Next, a quantization processing unit 608 performs quantization processing. Known error diffusion processing or dither processing can be used as the quantization processing. A binarization processing unit 609 generates binary data for each of CMYK by the index expansion. The K distribution thinning processing unit 610 generates, for each ink color, recording data indicating application (discharge) or non-application (non-discharge) of ink droplets from the recording head 5. As mentioned above, the recording head 5 is able to discharge three chromatic color inks for cyan (C), magenta (M), and yellow (Y) and two types of achromatic color inks for low-permeation black (K1) and high-permeation black (K2). In the present exemplary embodiment, the K distribution thinning processing unit 610 generates pieces of binary data corresponding to the respective two types of achromatic color inks based on K data generated by the binarization processing unit 609. Thus, the K data is able to be deemed as a pixel to which at least one of K1 ink and K2 ink is applied. Furthermore, since the recording head 5 is provided with two nozzle rows for discharging K1 ink, the K distribution thinning processing unit 610 generates pieces of data for the respective nozzle rows. The generated pieces of data include K1a data for the nozzle row 5d for discharging K1 ink and K1b data for the nozzle row 5f for discharging K1 ink.

### <K Distribution Thinning Processing>

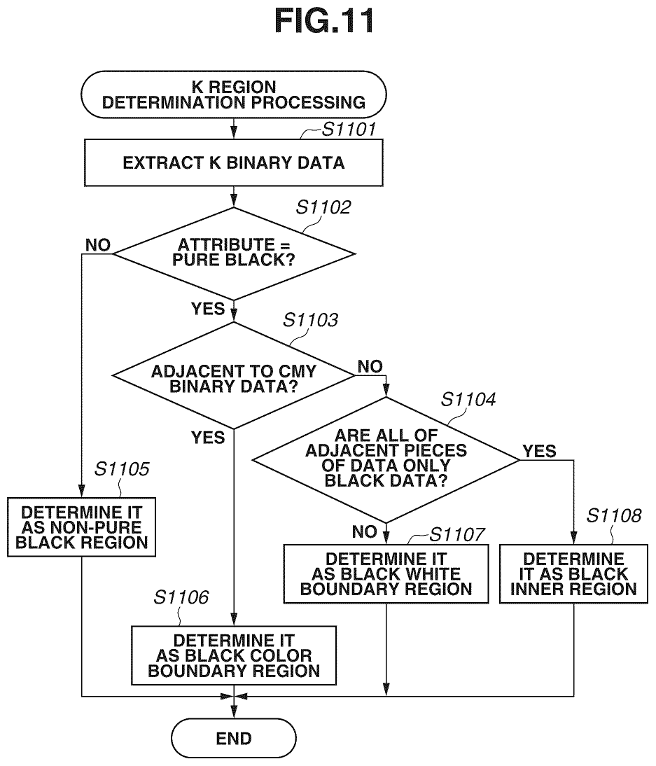

Next, K distribution thinning processing is described with reference to FIG. 11 to FIGS. 15A and 15B. First, the K distribution thinning processing determines a region by K region determination processing. Then, the K distribution thinning processing sets a thinning mask based on a result of the determination and performs thinning processing.

FIG. 11 is flowchart of the K region determination processing, which is performed by the K distribution thinning processing unit 610. The K region determination processing is executed by the CPU 20a according to a control program stored in the ROM 20c. Here, processing for classifying respective pixels for K data subjected to binarization into one of a black color boundary region, a black white boundary region, a black inner region, and a non-pure black region is performed.

In the following, the definition of each of the above-mentioned four regions is described. Each of three regions, i.e., the black color boundary region, the black white boundary region, and the black inner region, is a region composed of pixels indicating black color in the above-mentioned input data. A pixel indicating black color in input data is, as mentioned above, a pixel of (R, G, B)=(0, 0, 0) or (C, M, Y, K)=(0, 0, 0, 255) in input data, and is a pixel with an attribute added thereto in attribute data. In other words, pixels indicating black color in input data are classified into the above-mentioned three regions. The non-pure black region is a region composed of pixels indicating color not pure black, i.e., pixels in which color indicated by the input data is not black.

The black color boundary region is a region composed of pixels indicating black color in input data and is a region composed of pixels adjacent to pixels to which at least one color ink of C, M, and Y inks is applied.

The black white boundary region is a region composed of pixels indicating black color in input data and is a region composed of pixels adjacent to pixels to which no ink is applied. Thus, the black white boundary region is composed of pixels which are not adjacent to pixels to which color ink is applied and which are also not adjacent to pixels to which achromatic color ink is applied.

The black inner region is a region composed of pixels indicating black color in input data and is a region composed of black pixels all of the eight pixels located around each of which are black pixels. Here, a pixel for which the application (discharge) of ink has been determined based on K binary data is referred to as a “black pixel”.

First, in step S1101, when starting the K region determination processing, the CPU 20a extracts only binary data for K corresponding to achromatic color ink (hereinafter also referred to as “K binary data”) based on binary data and attribute data for each of CMYK generated by the binarization processing unit 609.

Next, in step S1102, the CPU 20a determines whether, with respect to each of the black pixels, the attribute of a pixel corresponding to the attribute data is a pixel indicating pure black. If it is determined that the attribute is a pixel indicating pure black (YES in step S1102), the CPU 20a advances the processing to step S1103. If it is determined that the attribute is not a pixel indicating pure black (NO in step S1102), the CPU 20a determines that the pixel concerned is a pixel to which achromatic color ink is applied but which is not jet black (pure black). The CPU 20a sets a region composed of this pixel as a non-pure black region, and advances the processing to step S1105.

Next, in step S1103, the CPU 20a determines whether a pixel to which achromatic color ink is applied in K binary data is adjacent to a pixel to which color ink is applied, based on binary data corresponding to C, M, Y color inks (hereinafter also referred to as “CMY binary data”). Here, the logical sum (OR) of respective pieces of binary data for C, M, and Y is set as CMY binary data. Thus, a pixel of “1” in CMY binary data is a pixel to which at least one of C, M, and Y inks is applied, and a pixel of “O” in CMY binary data is a pixel to which none of C, M, and Y inks is applied. If, in step S1103, it is determined that the pixel concerned is a pixel adjacent to CMY binary data (YES in step S1103), the CPU 20a advances the processing to step S1106, and, then, the CPU 20a determines that the pixel concerned is a pixel in the black color boundary region. If it is determined that the pixel concerned is a pixel not adjacent to CMY binary data (NO in step S1103), the CPU 20a advances the processing to step S1104, and, then, the CPU 20a determines whether all of the surrounding pixels adjacent to the pixel concerned are black pixels. Then, if, in step S1104, it is determined that all of the surrounding pixels adjacent to the pixel concerned are black pixels (YES in step S1104), the CPU 20a advances the processing to step S1108, and, then, the CPU 20a determines that the pixel concerned is a pixel in the black inner region. On the other hand, if it is determined that not all of the surrounding pixels adjacent to the pixel concerned are black pixels (NO in step S1104), the CPU 20a advances the processing to step S1107, and, then, the CPU 20a determines that the pixel concerned is a pixel in the black white boundary region.

In the determination processing in step S1103 in the present exemplary embodiment, the CPU 20a takes the logical product of CMY bold data obtained by performing bold processing on CMY binary data and K binary data, thus determining whether the pixel concerned is a pixel adjacent to the above-mentioned CMY binary data.

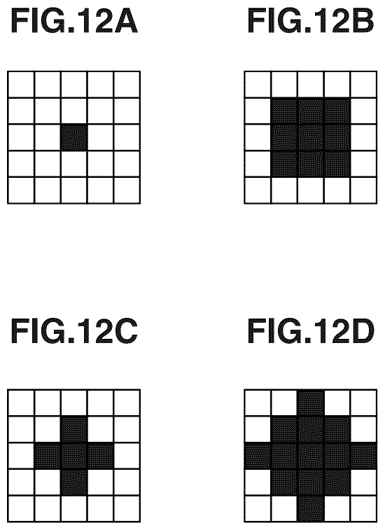

FIGS. 12A, 12B, 12C, and 12D are diagrams used to explain bold processing. The bold processing refers to processing for extending (making bold) data in such a manner that pixels around a pixel to which ink is applied are also treated as pixels to which ink is applied. In the present exemplary embodiment, the bold processing performs bold processing on eight pixels located around the pixel of interest. In a case where, as illustrated in FIG. 12A, one pixel central in a region of 5 pixels×5 pixels is determined to be subjected to the application of ink, when the bold processing in the present exemplary embodiment is performed, bold data for determining the application of ink to one central pixel and eight pixels surrounding the one central pixel is generated as illustrated in FIG. 12B.

Furthermore, while, in the present exemplary embodiment, a configuration in which surrounding eight pixels are subjected to bold processing has been described, the amount of bold processing to be performed can be different amounts as appropriate. For example, as illustrated in FIG. 12C, a configuration in which pixels located in diagonal directions are not subjected to bold processing and one pixel is subjected to bold processing only in vertical directions and horizontal directions can be employed. Moreover, the amount of bold processing to be performed can be made different depending on directions, and a configuration in which, as illustrated in FIG. 12D, two pixels are subjected to bold processing in vertical directions and horizontal directions and one pixel is subjected to bold processing in diagonal directions can be employed.

Then, the CPU 20a takes the logical product (AND) of the CMY bold data generated as mentioned above and the K binary data. The CPU 20a determines that a pixel for which the result of the logical product is “1” is a pixel included in the black color boundary region and a pixel for which the result of the logical product is “0” is a pixel included in the black inner region.

Even in step S1104, the CPU 20a determines whether, in K binary data, all of the pieces of data for eight surrounding pixels are data of “1” indicating the application of K ink, thus being able to determine whether one adjacent and surrounding pixel is a black pixel. Furthermore, the number of adjacent and surrounding pixels is not limited to this. For example, in the case of determining whether two surrounding pixels are black pixels, the CPU 20a only needs to determine whether data for 24 surrounding pixels is data of “1” indicating the application of K ink.

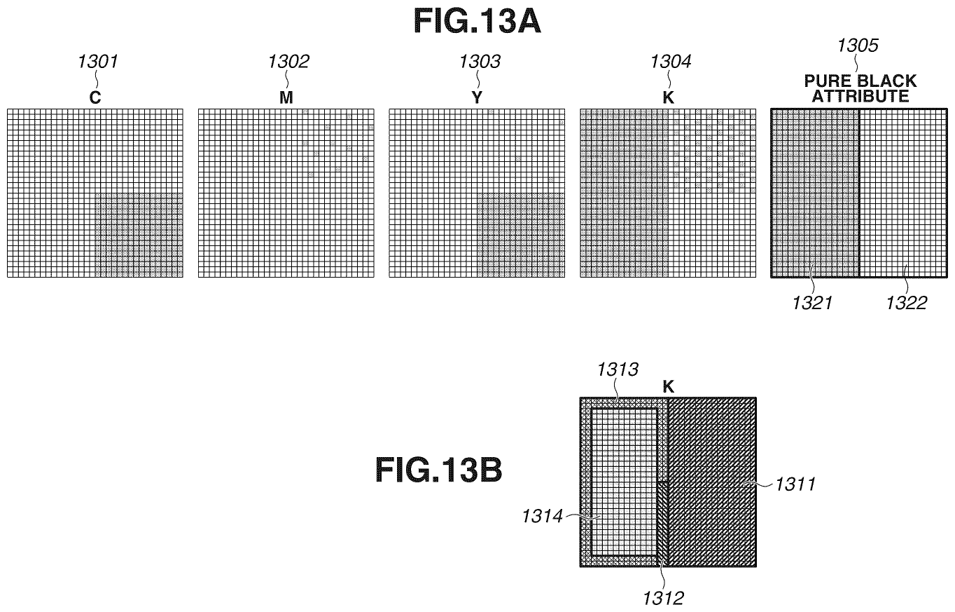

FIGS. 13A and 13B are diagrams illustrating an example of K region determination processing. FIG. 13A illustrates input data for the K region determination processing, which includes binary data 1301 for C, binary data 1302 for M, binary data 1303 for Y, binary data 1304 for K, and attribute data 1305 indicating the pure black attribute. The attribute data 1305 includes a region 1321, which is a region composed of pure black pixels having been input as black, and a region 1322, which is a region composed of pixels indicating colors which are not black.

FIG. 13B is a diagram illustrating a determination result for the K region determination processing with respect to the input data illustrated in FIG. 13A. The illustrated determination result indicates that the region 1311 is a non-pure black region, the region 1312 is a black color boundary region, the region 1313 is a black white boundary region, and the region 1314 is a black inner region. Here, an example of the case where boundary regions between black and color and between white and color are two pixels is illustrated.

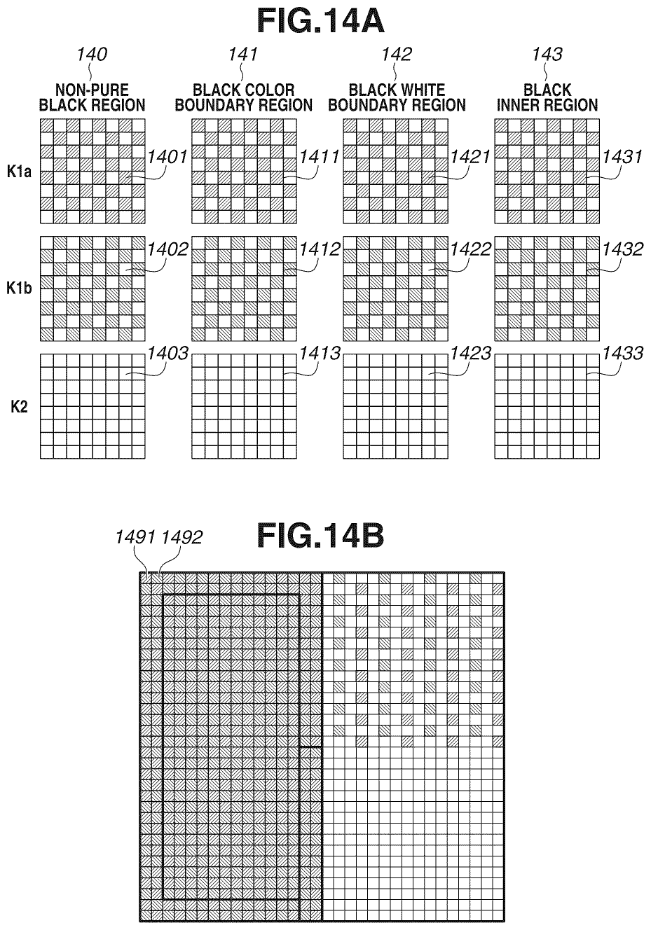

Next, processing for distributing respective ink colors which are discharged from the recording head 5 to the respective regions determined in the K region determination processing is described with reference to FIGS. 14A and 14B. FIG. 14A illustrates an example of a thinning mask set. Masks 140 are a thinning mask set for pixels determined as a non-pure black region. A mask 1401 is a mask for K1a data (data for the nozzle row 5d for discharging low-permeation black ink (K1), a mask 1402 is a mask for K1b data (data for the nozzle row 5f for discharging low-permeation black ink (K1), and a mask 1403 is a mask for K2 data (data for the nozzle row 5e for discharging high-permeation black ink (K2)).

Masks 141 are a thinning mask set for pixels determined as a black color boundary region. A mask 1411 is a mask for K1a data, a mask 1412 is a mask for K1b data, and a mask 1413 is a mask for K2 data.

Masks 142 are a thinning mask set for pixels determined as a black white boundary region. A mask 1421 is a mask for K1a data, a mask 1422 is a mask for K1b data, and a mask 1423 is a mask for K2 data.

Masks 143 are a thinning mask set for pixels determined as a black inner region.

A mask 1431 is a mask for K1a data, a mask 1432 is a mask for K1b data, and a mask 1433 is a mask for K2 data.

FIG. 14B illustrates a result obtained by performing thinning on the respective regions illustrated in FIG. 13B with use of the masks illustrated in FIG. 14A. The thinning rate of each of the mask 1401 and the mask 1402 is 50%, and, since their dot arrangements are in an exclusive relationship, the thinning rate of a combination of the mask 1401 and the mask 1402 becomes 0%. Thus, with respect to a region with 100% of input pixels K, data with 100% in total of K1a data with 50% and K1b data with 50% is recorded.

Since the thinning rate of the mask 1403 is 100%, with respect to a region with 100% of input pixels K, the recording rate becomes 0%, so that all of the pieces of data are thinned out.

The thinning rate of each of the mask 1411 and the mask 1412 is 50%, and, since their dot arrangements are in an exclusive relationship, the thinning rate of a combination of the mask 1411 and the mask 1412 becomes 0%. Thus, with respect to a region with 100% of input pixels K, data with 100% in total of K1a data with 50% and K1b data with 50% is recorded.

Since the thinning rate of the mask 1413 is 100%, with respect to a region with 100% of input pixels K, the recording rate becomes 0%, so that all of the pieces of data are thinned out.

The thinning rate of each of the mask 1421 and the mask 1422 is 50%, and, since their dot arrangements are in an exclusive relationship, the thinning rate of a combination of the mask 1421 and the mask 1422 becomes 0%. Thus, with respect to a region with 100% of input pixels K, data with 100% in total of K1a data with 50% and K1b data with 50% is recorded.

Since the thinning rate of the mask 1423 is 100%, with respect to a region with 100% of input pixels K, the recording rate becomes 0%, so that all of the pieces of data are thinned out.

The thinning rate of each of the mask 1431 and the mask 1432 is 50%, and, since their dot arrangements are in an exclusive relationship, the thinning rate of a combination of the mask 1431 and the mask 1432 becomes 0%. Thus, with respect to a region with 100% of input pixels K, data with 100% in total of K1a data with 50% and K1b data with 50% is recorded.

Since the thinning rate of the mask 1433 is 100%, with respect to a region with 100% of input pixels K, the recording rate becomes 0%, so that all of the pieces of data are thinned out.

In the present example, since the thinning masks for the respective regions are the same, in any region, thinning is performed and data distribution is performed in the same manner. With respect to a K input image, thinning is not performed and 100% thereof is recorded with only K1 ink.

A pixel 1491 is a pixel which is recorded with only K1a data, i.e., is recorded with K1 ink by the nozzle row 5d, and a pixel 1492 is a pixel which is recorded with only K1b data, i.e., is recorded with K1 ink by the nozzle row 5f.

Such parameters for the K distribution thinning processing illustrated in FIGS. 14A and 14B are set as a “set 1”, and are specified in a recording mode information table illustrated in FIG. 10 described below.

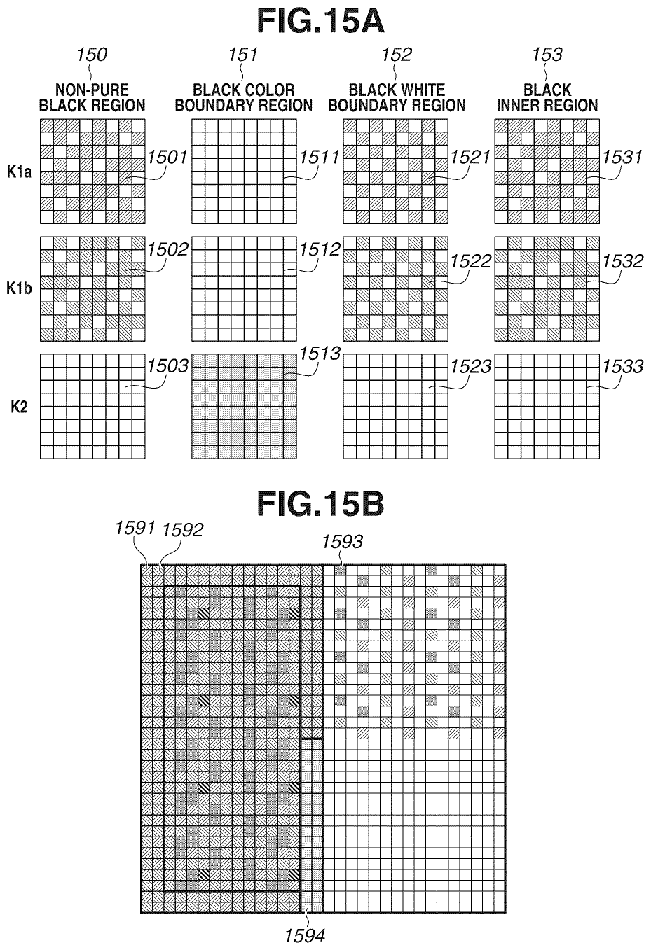

FIGS. 15A and 15B illustrate an example in which a thinning mask set different from that illustrated in FIG. 14A is used.

Masks 150 are a thinning mask set for pixels determined as a non-pure black region. A mask 1501 is a mask for K1a data, a mask 1502 is a mask for K1b data, and a mask 1503 is a mask for K2 data.

Masks 151 are a thinning mask set for pixels determined as a black color boundary region. A mask 1511 is a mask for K1a data, a mask 1512 is a mask for K1b data, and a mask 1513 is a mask for K2 data.

Masks 152 are a thinning mask set for pixels determined as a black white boundary region. A mask 1521 is a mask for K1a data, a mask 1522 is a mask for K1b data, and a mask 1523 is a mask for K2 data.

Masks 153 are a thinning mask set for pixels determined as a black inner region.

A mask 1531 is a mask for K1a data, a mask 1532 is a mask for K1b data, and a mask 1533 is a mask for K2 data.

FIG. 15B illustrates a result obtained by performing thinning on the respective regions illustrated in FIG. 13B with use of the masks illustrated in FIG. 15A. The thinning rate of each of the mask 1501 and the mask 1502 is 37.5%. Thus, with respect to a region with 100% of input pixels K, data with 125% in total of K1a data with 62.5% and K1b data with 62.5% is recorded.

Since the thinning rate of the mask 1503 is 100%, with respect to a region with 100% of input pixels K, the recording rate becomes 0%, so that all of the pieces of data are thinned out.

Since the thinning rate of each of the mask 1511 and the mask 1512 is 100%, with respect to a region with 100% of input pixels K, the recording rate becomes 0%, so that all of the pieces of data are thinned out.

Since the thinning rate of the mask 1513 is 0%, with respect to a region with 100% of input pixels K, 100% of data is recorded without being thinned out.

The thinning rate of each of the mask 1521 and the mask 1522 is 50%, and, since their dot arrangements are in an exclusive relationship, the thinning rate of a combination of the mask 1521 and the mask 1522 becomes 0%. Thus, with respect to a region with 100% of input pixels K, data with 100% in total of K1a data with 50% and K1b data with 50% is recorded.

Since the thinning rate of the mask 1523 is 100%, with respect to a region with 100% of input pixels K, the recording rate becomes 0%, so that all of the pieces of data are thinned out.

Each of the mask 1531 and the mask 1532 is a mask with a thinning rate of 37.5%.

Thus, with respect to a region with 100% of input pixels K, data with 125% in total of K1a data with 62.5% and K1b data with 62.5% is recorded.

Since the thinning rate of the mask 1533 is 100%, with respect to a region with 100% of input pixels K, the recording rate becomes 0%, so that all of the pieces of data are thinned out.

In the present example, since the thinning masks for the non-pure black region and the black inner region are the same, in any region, thinning is performed and data distribution is performed in the same manner. With respect to a K input image, data with 125% is recorded with only K1 ink.

A pixel 1591 is a pixel which is recorded with only K1a data, i.e., is recorded with K1 ink by the nozzle row 5d, and a pixel 1592 is a pixel which is recorded with only K1b data, i.e., is recorded with K1 ink by the nozzle row 5f. A pixel 1593 is a pixel which is recorded with K1a data and K1b data, i.e., is recorded with K1 ink by the nozzle row 5d and the nozzle row 5f.

Such parameters for the K distribution thinning processing illustrated in FIGS. 15A and 15B are set as a “set 2”, and are specified in a recording mode information table illustrated in FIG. 10 described below.

### <Density Characteristic Value Acquisition Processing>

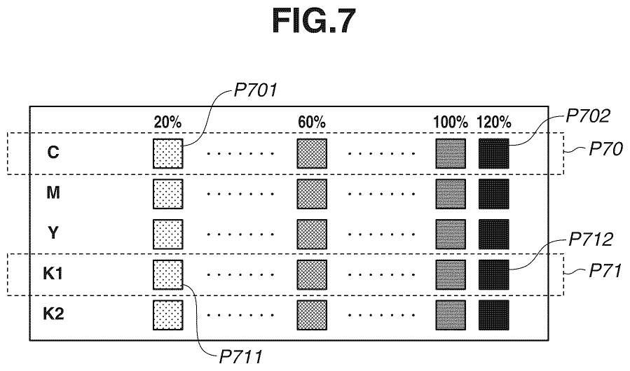

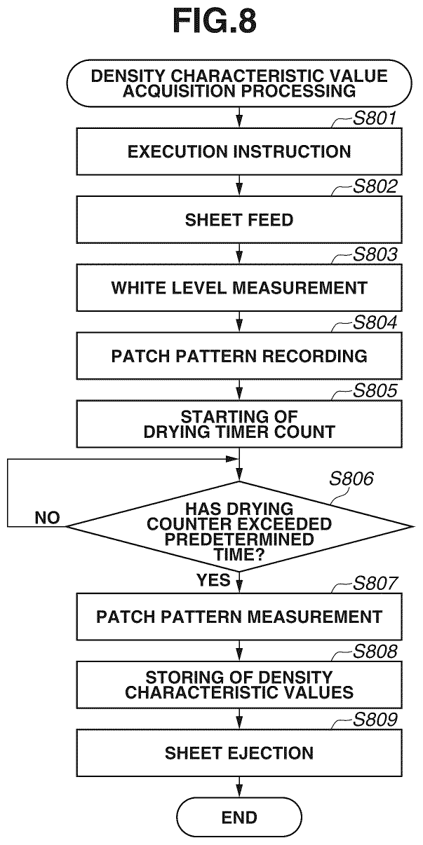

Next, density characteristic value acquisition processing in the present exemplary embodiment is described with reference to FIG. 7 and FIG. 8.

FIG. 7 illustrates an example of a patch pattern used to acquire density characteristic values. A plurality of patches is recorded with amounts of ink to be applied (applying amounts) varied with 20% increments with respect to the respective inks for cyan (C), magenta (M), yellow (Y), and black (K1 and K2).

For example, a patch group P70 for cyan is recorded with only cyan ink discharged from the nozzle row 5a.

A patch P701 is recorded with an applying amount of cyan ink 20%, and a patch P702 is recorded with an applying amount of cyan ink 120%.

A patch group P71 for black (K1) is recorded with only K1 ink discharged from the nozzle row 5d and the nozzle row 5f. A patch P711 is recorded with an applying amount of K1 ink 20%, and a patch P712 is recorded with an applying amount of K1 ink 120%.

The applying amount refers to the rate of the number of ink dots to be recorded on paper. The recording apparatus in the present exemplary embodiment has a recording resolution of 1,200 dpi×1,200 dpi. In a case where a unit area of 1,200 dpi×1,200 dpi is defined as one grid, a state in which every one dot is recorded per unit area is assumed to be 100%. Similarly, a state in which every two dots are recorded in every grid included in a predetermined region, i.e., a state in which dots the number of which is twice as compared with 100% are recorded, is assumed to be 200%. The position at which a dot is formed does not necessarily need to be the center of a grid, and a dot can be recorded in a space between adjacent grids.

The patch group P71 for black (K1) is recorded by using the nozzle row 5d and the nozzle row 5f at the rate of 50% for each. The rate for such use is not limited to this. Another pattern can be recorded depending on the rate for such use.

FIG. 8 is a flowchart illustrating the density characteristic value acquisition processing. When, in step S801, an execution instruction for the density characteristic value acquisition processing is input, then in step S802, the CPU 20a of the recording apparatus 200 drives the sheet feed motor 24 and thus starts supplying of a recording medium from, for example, a roll paper holding unit or a sheet feed position. When the recording medium P is conveyed to below the multipurpose sensor 102, then in step S803, the CPU 20a measures the reflection intensity (hereinafter referred to as a “white level”) of a white space region of the recording medium, in which no patch pattern is recorded, with use of the green LED 404, the blue LED 405, and the red LED 406 of the multipurpose sensor 102. The result of measurement of the white level is used as a reference value for use in performing density value calculation of a patch pattern which is to be recording after this. The value of the white level is retained for each LED. Furthermore, the density of a white space region of the recording medium is white in base color if the recording medium is a white recording medium. In the present exemplary embodiment, an example in which a recording medium with white base color is used is described.

When the recording medium P is conveyed to a region available for recording by the recording head 5 and is determined to be ready for recording, then in step S804, the CPU 20a records a patch pattern for acquiring recording characteristics of every nozzle row described above with reference to FIG. 7. The CPU 20a records the patch pattern by alternately performing a conveyance operation in the Y-direction of the recording medium P and a recording scanning operation in the X-direction of the carriage unit 2 driven by the carriage motor 23.

In step S805, the CPU 20a starts counting of a drying timer for waiting for a predetermined time to dry the recorded patch pattern. In step S806, the CPU 20a determines whether the counter of the drying timer has detected the elapse of the predetermined time, and, if it is determined that the counter of the drying timer has detected the elapse of the predetermined time (YES in step S806), the CPU 20a advances the processing to step S807, and, then, the 20a measures the reflection intensity of the patch pattern. The CPU 20a turns on an LED suited for an ink color targeted for measurement of the LEDs 404 to 406 mounted in the multipurpose sensor 102 and causes the phototransistors 402 and 403 to read reflection light, thus measuring the reflection intensity. The green LED 404 is turned on to measure a patch pattern recorded with, for example, magenta ink and a white space region. The blue LED 405 is turned on to measure a patch pattern recorded with, for example, yellow ink and black ink and a white space region. The red LED 406 is turned on to measure a patch pattern recorded with, for example, cyan ink and a white space region.

Upon completion of measurement of the reflection intensity of the patch pattern, in step S808, the CPU 20a calculates density values of the patch pattern for the respective corresponding nozzle rows based on the output values of the respective patch patterns and white levels. The calculated density values are then stored, as density characteristic value information for setting the above-mentioned 1D-LUT 622 for color misregistration correction, in the memory 506 or the RAM 20b included in the recording apparatus 200. With respect to an ink color for which the green LED 404 is used for reading of the patch pattern, the output value of a white level read with the green LED 404 is used. Similarly, with respect to an ink color for which the blue LED 405 is used for reading of the patch pattern, the output value of a white level read with the blue LED 405 is used, and, with respect to an ink color for which the red LED 406 is used for reading of the patch pattern, the output value of a white level read with the red LED 406 is used.

Here, the density value is calculated as a value obtained by multiplying the reflection intensity of a patch, which is obtained when the reflection intensity of a white space region is set as 100%, by logarithm. For example, the density value ODm of a patch pattern recorded with magenta ink is calculated by the following formula (1) when the white level read with the green LED 404 is denoted by Gw and the patch read value is denoted by Gm:

$$ODm = - log ( Gm / Gw ) . \qquad ( 1 )$$

In step S809, the CPU 20a causes the recording medium P to be ejected to the outside, and then ends the processing.

### <Color Misregistration Correction Table Generation Processing>

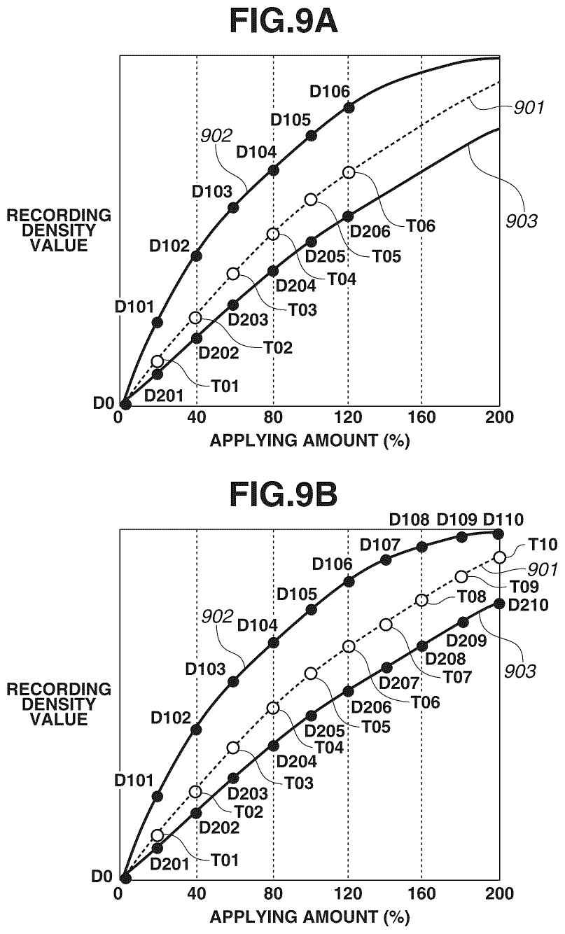

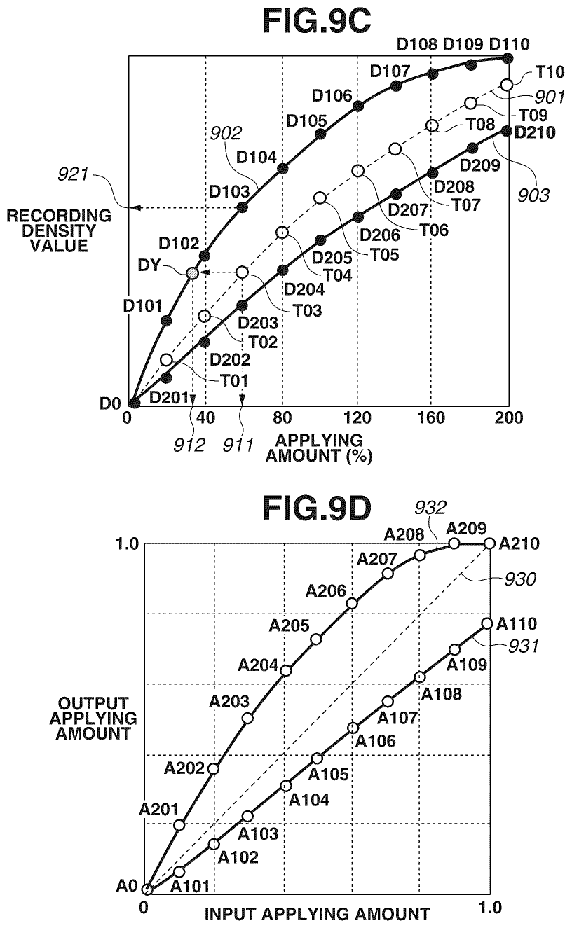

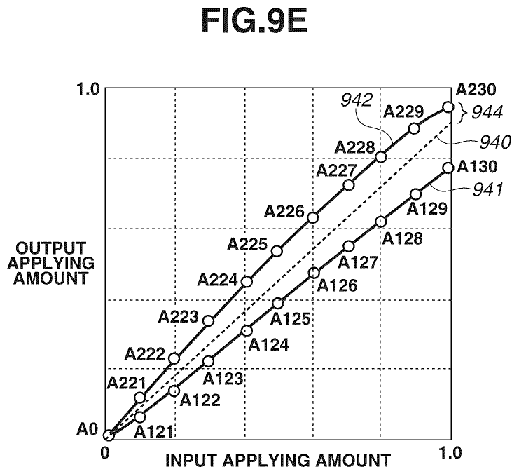

Next, a generation method for the color misregistration correction table 622 is described with reference to FIGS. 9A, 9B, 9C, 9D, and 9E. Here, a generation method for a color misregistration correction table for the recording mode 9 (the output upper limit rank described below being the rank A, i.e., the maximum applying amount being 200%) shown in the recording mode information table illustrated in FIG. 10 is described.

FIG. 9A is a diagram used to explain density characteristic values associated with the applying amount. FIG. 9A illustrates an example for one type of ink regarding a given type of recording medium. The horizontal axis indicates an ink applying amount (%) for use in recording a patch, and the vertical axis indicates a recording density value obtained by reading the patch.

In FIG. 9A, a dashed line 901 indicates a recording density value at a reference machine for an input data value, and indicates a target density value in color calibration. The reference machine is a recording apparatus 200 serving as a benchmark, and refers to a recording apparatus having a recording head taking the center value of variations of the ink discharge amount mounted thereon and serving as a benchmark. Information about this target density value can be preliminarily stored in a storage unit included in the recording apparatus, can be generated inside the recording apparatus, or can be configured to be acquired from an external apparatus.

A solid line 902 indicates a recording density value for an ink color at an actual machine A, and a solid line 903 indicates a recording density value for an ink color at an actual machine B. The actual machine refers to a recording apparatus 200 which is targeted for performing color misregistration correction by color calibration. Information about this recording density value is acquired by the density characteristic value acquisition processing illustrated in FIG. 8 described above.

Points D101 to D106 indicate densities (calculated by formula (1)) corresponding to the respective patches with 20% increments from 20% to 120% in the patch chart at the actual machine A, and point DO indicates a density of paper white.

The solid line 902 is a line calculated by, for example, interpolation processing or approximate curve from the measured values at the points DO and D101 to D106. It is understood that the actual machine A indicated by the solid line 902 is large in the amount of ink discharge and performs recording at densities higher than those at the reference machine.

Points D201 to D206 indicate densities (calculated by formula (1)) corresponding to the respective patches with 20% increments from 20% to 120% in the patch chart at the actual machine B. The solid line 903 is a line calculated by, for example, interpolation processing or approximate curve from the measured values at the points DO and D201 to D206. It is understood that the actual machine B indicated by the solid line 903 is small in the amount of ink discharge and performs recording at densities lower than those at the reference machine.

Furthermore, since the applying amount for the patch chart in the present exemplary embodiment is up to 120%, the CPU 20a can be configured to predict a density value obtained in consideration of an applying amount exceeding the maximum applying amount for the patch chart in conformity with the maximum applying amount available for recording by the recording apparatus. For example, in a case where the maximum applying amount available for recording by the recording apparatus is 200%, the CPU 20a obtains, by prediction, a recording density value for the applying amount larger than 120%. Specifically, the CPU 20a performs extrapolation by using a typical approximate or interpolation method such as polynomial approximation or spline interpolation. FIG. 9B is a diagram illustrating addition of predicted recording densities (for example, points D107 to D110). Naturally, the CPU 20a can also be configured to record patches up to the maximum applying amount and acquire density values as appropriate.

FIG. 9C is a diagram used to explain generation of the color misregistration correction table 622. Correction processing to be performed by the color misregistration correction processing unit 607 is to perform conversion correction of a contone (continuous tone) color material signal by each ink color in such a way as to reach the recording density at the reference machine, so that the color misregistration correction table is used to perform correction processing. The value 921 indicates a recording density value for the patch with an applying amount of 60% (911) recorded at the actual machine A. This value is a density higher than the target density T03 with the same applying amount. Therefore, the actual machine A is intended to decrease the applying amount and conform the recording density to the target value. Specifically, the CPU 20a searches for an applying amount for the actual machine A serving as a density value equivalent to the target density T03 from the curve 902, thus obtaining a value DY. Thus, if recording is performed with the applying amount 912 corresponding to the value DY at the actual machine A, the obtained density value becomes approximately equal to the target density value. Performing this processing from the points DO and D101 to the point D110 enables obtaining a relationship of the output applying amount (%) for the actual machine A to the input applying amount (%) for the actual machine A. This relationship becomes a color misregistration correction table 622 which is a 1D-LUT.

With respect to the actual machine B, also performing similar processing from the points DO and D201 to the point D210 enables obtaining a relationship of the output applying amount (%) for the actual machine B to the input applying amount (%) for the actual machine B, so that a color misregistration correction table 622 which is a 1D-LUT is generated.

FIG. 9D is a diagram illustrating a color misregistration correction table 622 for the actual machine A and the actual machine B. Here, the ink applying amount is converted into an input count value. The case where the applying amount is 200% is normalized as a count value of 1.0. Since the maximum value of the applying amount differs depending on recording modes, in the case of a recording mode with a maximum applying amount of 150%, 150% is a count value of 1.0, and, in the case of a recording mode with a maximum applying amount of 100%, 100% is a count value of 1.0.

A dashed line 930 indicates a relationship between the input applying amount and the output applying amount in the case of not performing color misregistration correction processing, thus indicating characteristics of the reference machine. With regard to the actual machine A, a color misregistration correction table 622 corresponding to the solid line 931 is generated in such a manner that the output applying amount becomes smaller with respect to the input applying amount. With regard to the actual machine B, a color misregistration correction table 622 corresponding to the solid line 932 is generated in such a manner that the output applying amount becomes larger with respect to the input applying amount.

Furthermore, with respect to the points D208, D209, and D210, in a case where correction values for applying up to the maximum amount are set, gradation collapse may occur. Therefore, with regard to the solid line 932, such correction values as to monotonously increase the applying amount are set in such a way as to prevent gradation collapse from occurring.

FIG. 9E illustrates an example of a color misregistration correction table 622 in a case where there is a number-of-applications surplus. In this case, gradation collapse becomes unlikely to occur. The number-of-applications surplus refers to the number of applications indicated by an amount 944, and occurs in a case where, with respect to the maximum input applying amount being 200% (an input count value of 1.0 in FIG. 9E), the output applying amount for the reference machine indicated by a dashed line 940 becomes less than 200% (an output count value of 1.0 in FIG. 9E). In this case, even in a recording head in which the amount of discharge in discharge performed once is less than that for the reference machine, it becomes possible to make the output applying amount larger than that for the reference machine, so that gradation collapse is unlikely to occur even in a high-gradation region. In the following description, an example of a case where a number-of-applications surplus does not occur is described.

While, in the color misregistration correction table illustrated in FIG. 9D, discrete values at 11 points are illustrated, the actual table is not limited to this. Discrete values at, for example, 256 points or 1,024 points obtained by interpolation using the measured 11 points or a correction parameter such as a numerical expression which is able to be defined by a curve can be employed.

### <Output Upper Limit Rank Information>

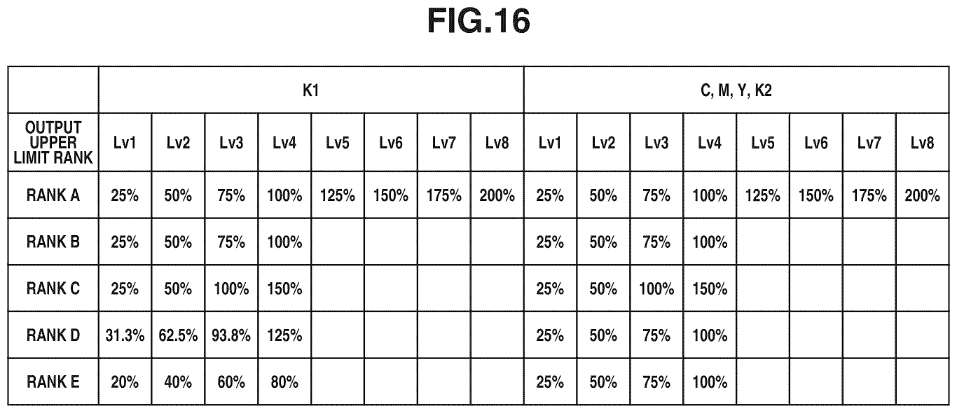

FIG. 16 illustrates an output upper limit rank information table which shows ink applying amounts relative to input gradation values for the respective ink colors for every piece of output upper limit rank information. While, in the recording mode information table illustrated in FIG. 10 described above, which of the ranks A to E the output upper limit rank is for every recording mode is set, the output upper limit rank information table illustrated in FIG. 16 shows applying amount information indicating ink applying amounts relative to input gradation values for the respective output upper limit ranks.

The rank A is a mode in which K1 ink is used for recording up to 200% and each of C, M, Y, and K2 inks is used for recording up to 200%, and is a mode in which the ink applying amount linearly increases at a constant inclination, such as 25%, 50%, 75%, 100%, 125%, 150%, 175%, and 200%, according to input gradations.

The rank B is a mode in which K1 ink is used for recording up to 100% and each of C, M, Y, and K2 inks is used for recording up to 100%, and is a mode in which the ink applying amount linearly increases at a constant inclination, such as 25%, 50%, 75%, and 100%, according to input gradations.

The rank C is a mode in which K1 ink is used for recording up to 150% and each of C, M, Y, and K2 inks is used for recording up to 150%, and is a mode in which the inclination associated with input gradations is not constant and the ink applying amount does not linearly increase, such as 25%, 50%, 100%, and 150%.

The rank D is a mode in which K1 ink is used for recording up to 125% and each of C, M, Y, and K2 inks is used for recording up to 100%, and is a mode in which the ink applying amount for K1 ink linearly increases at a constant inclination, such as 31.3%, 62.5%, 93.8%, and 125%, according to input gradations. The ink applying amount for each of C, M, Y, and K2 inks is the same as that in the rank B.

The rank E is a mode in which K1 ink is used for recording up to 80% and each of C, M, Y, and K2 inks is used for recording up to 100%, and is a mode in which the ink applying amount for K1 ink linearly increases at a constant inclination, such as 20%, 40%, 60%, and 80%, according to input gradations. The ink applying amount for each of C, M, Y, and K2 inks is the same as that in the rank B.

As mentioned above, there are various types of ink applying amounts. Furthermore, the applying amount information illustrated in FIG. 16 is merely an example, and the present exemplary embodiment is not limited to this. Moreover, the applying amount information indicated by the output upper limit rank information is information to be used for generation of a color misregistration correction table, and, since the actual applying amounts associated with gradations are corrected by the gradation correction processing unit 606, the present exemplary embodiment is not limited to this table.

The table illustrated in FIG. 16 retains the value of an ink applying amount for each of a plurality of input gradation values, but, with respect to a mode in which the ink applying mode linearly increases as in the rank D, only needs to retain the value of an ink applying amount associated with one input gradation value. On the other hand, with respect to a mode in which the ink applying amount does not linearly increase as in the rank C, it is desirable that the table illustrated in FIG. 16 retains values of ink applying amounts for the respective plurality of input gradation values.

<Generation of Correction Table Compatible with a Plurality of Modes Different in the Applying Amount>

Next, a generation method for a color misregistration correction table in a recording mode in which the maximum applying amount for each ink color is not 200% is described. The color misregistration correction table 622 described above with reference to FIGS. 9A to 9E is a generation method for a table for use in the recording mode 9 in which the output upper limit rank is the rank A, i.e., the maximum applying amount is 200%.

However, in a general recording apparatus, a plurality of recording qualities, such as “fast”, “standard”, and “beautiful”, is allowed to be selected. Recording modes are provided in association with recording qualities, and the maximum applying amount is set for each recording mode.

Moreover, since, as mentioned above, the K distribution thinning processing is performed after the color misregistration correction processing, the ink applying amount determined by the color misregistration correction processing is caused to change. Accordingly, it is preferable to preliminarily take into account the maximum applying amount associated with the input gradation value obtained after the K distribution thinning processing. In this regard, using the output upper limit rank information set in the recording mode information table illustrated in FIG. 10 enables generating a color misregistration correction table associated with the ink applying amount obtained after the K distribution thinning processing.

On the other hand, performing the density characteristic value acquisition processing and the color misregistration correction table generation processing with respect to all of the recording modes makes the processing load higher. Moreover, since it is also preferable to retain target density values for the number of ranks in the output upper limit rank information, a large memory capacity is useful. However, the present exemplary embodiment is configured not to perform the density characteristic value acquisition processing for each recording mode but to generate a color misregistration correction table for another recording mode from the measured value of a recording density value (FIG. 9A) for a given rank and the target density value.

With regard to a plurality of recording qualities, specifically, in the case of the recording quality “fast”, the applying amount is small and the recording speed is high. In the case of the recording quality “beautiful”, the applying amount is large and the recording speed is low. In the case of the recording quality “standard”, the applying amount and the recording speed take values between the recording qualities “fast” and “beautiful”. The plurality of recording qualities is allowed to be selected in such a manner that a user who gives importance to the image quality of recording selects the recording quality “beautiful” and a user who gives importance to the recording speed selects the recording quality “fast”. Furthermore, reducing the recording resolution in the scanning directions to ½ to increase the scanning speed of the carriage unit 2 may result in the available applying amount decreasing to ½.

More, with regard to the low-permeation black ink (K1), increasing the applying amount causes an increase in density, thus improving visual quality. On the other hand, since K1 ink is low in the fixability to a recording medium, if a recording surface with a large amount of K1 ink applied thereto is rubbed with fingers, ink trail may occur on the recording surface. In consideration of such a trade-off between recording density and fixability, the maximum applying amount is set for every type of recording medium and for every recording mode.

Specifically, as described above with reference to FIGS. 14A and 14B and FIGS. 15A and 15B, the above-mentioned K distribution thinning processing unit 610 adjusting the recording rates for masks in distributing pieces of K data corresponding to K1 ink and K2 ink to the respective nozzle rows, and thus causes the total of maximum applying amounts to be set.

As just described, in a case where the maximum applying amount differs depending on recording modes, even if the maximum applying amount is previously determined by the color misregistration correction processing unit 607, the maximum applying amount may change due to the thinning processing subsequently performed by the K distribution thinning processing unit 610. Therefore, to generate a color misregistration correction table, there is a method of recording a patch pattern for every recording mode and thus acquiring a density characteristic value for every gradation. However, estimating, based on density characteristic values (FIG. 9A) acquired by performing recording at a recording quality with a large applying amount (in the present exemplary embodiment, the recording quality “beautiful”), density characteristic values for the other recording modes enables making it enough to perform recording of a patch pattern and measuring by a sensor only once.

In the present exemplary embodiment, as illustrated in FIG. 10, the quality “beautiful” for glossy paper enters into the recording mode 9, in which the output upper limit rank is the rank A and the maximum ink applying amount is 200%. Similarly, the quality “standard” for glossy paper enters into the recording mode 8, in which the output upper limit rank is the rank C and the maximum ink applying amount is 150%. The quality “fast” for glossy paper enters into the recording mode 7, in which the output upper limit rank is the rank B and the maximum ink applying amount is 100%. Then, there is a case where the quality “standard” for plain paper enters into the recording mode 2, in which, due to the K distribution thinning processing, the output upper limit rank is the rank D, the maximum applying amount for K1 ink is 125%, and the maximum applying amount for each of C, M, Y, and K2 inks is 100%. Here, an example of estimating, based on the density characteristic value for the applying amount 200% in the rank A as an output upper limit rank, density characteristic values for the other qualities, thus generating a color misregistration correction table, is described.

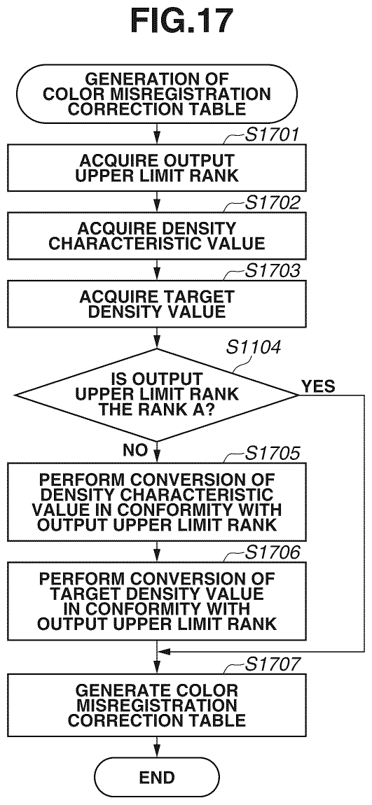

FIG. 17 is a flowchart used to explain generation processing for a color misregistration correction table which is compatible with not only a recording mode for the rank A with a maximum applying amount of 200% but also recording modes other than the recording mode for the rank A.

First, in step S1701, the CPU 20a acquires an output upper limit rank, illustrated in FIG. 16, of a recording mode to be corrected. Then, in step S1702, the CPU 20a acquires a density characteristic value, and, in step S1703, acquires a target density value. The density characteristic value and the target density value to be acquired here are the measured value and the target value of a patch pattern recorded in the recording mode 9 (the rank A and the maximum applying amount being 200%) in the recording mode information table illustrated in FIG. 10.

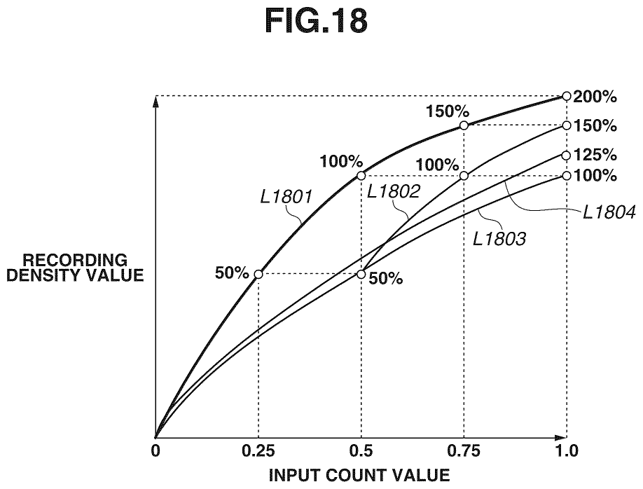

In step S1704, the CPU 20a determines whether the output upper limit rank is the rank A, and, if it is determined that the output upper limit rank is the rank A (YES in step S1704), the CPU 20a advances the processing to step S1707. In step S1707, the CPU 20a generates a color misregistration correction table, by the method described above with reference to FIGS. 9A to 9E, based on the density characteristic value acquired in step S1702 and the target density value acquired in step S1703. If, in step S1704, it is determined that the acquired output upper limit rank is not the rank A (NO in step S1704), then in step S1705 and step S1706, the CPU 20a performs conversion processing on the density characteristic value and the target density value in conformity with the acquired output upper limit rank. This conversion processing is described with reference to FIG. 18 to FIG. 20.

FIG. 18 is a diagram used to explain conversion processing of the density characteristic value and the target density value conforming to the output upper limit rank. Specifically, FIG. 18 is a diagram illustrating recording density values associated with input counter values for every recording medium based on a relationship between the respective gradation values and applying amounts of the output upper limit rank illustrated in FIG. 16. With regard to a line L1801 in which the output upper limit rank is the rank A, when the input count value is 0, 0.25, 0.5, 0.75, and 1.0, the applying amount is 0%, 50%, 100%, 150%, and 200%, respectively. With regard to a line L1802 in which the output upper limit rank is the rank C, when the input count value is 0, 0.5, 0.75, and 1.0, the applying amount is 0%, 50%, 100%, and 150%, respectively. With regard to a line L1803 in which the output upper limit rank is the rank B, when the input count value is 0, 0.5, and 1.0, the applying amount is 0%, 50%, and 100%, respectively.

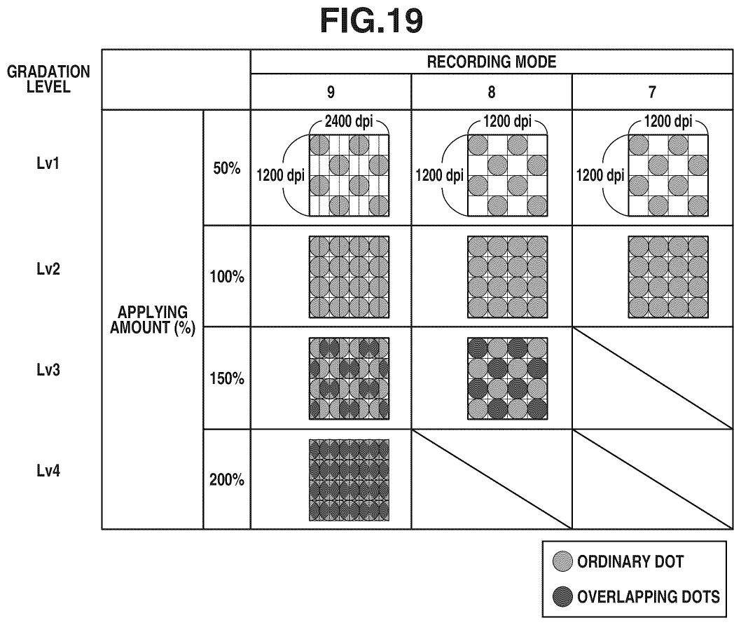

Furthermore, in a case where the output upper limit rank is the rank C, the maximum applying amount for each color is “150%” and there is an inflection point at the gradation level Lv2. This is because, as illustrated in FIG. 19, in the recording mode in which the output upper limit rank is the rank C, in the gradation level Lv2, in which the applying amount is 100%, and subsequent gradation levels, there are pixels in each of which two dots are applied in an overlapping manner.

Based on such a relationship, conversion from the density recording value in which the output upper limit rank is the rank A into the density recording values in which the output upper limit rank is the other ranks, so that the recording density value associated with the input count value for each output upper limit rank is estimated.

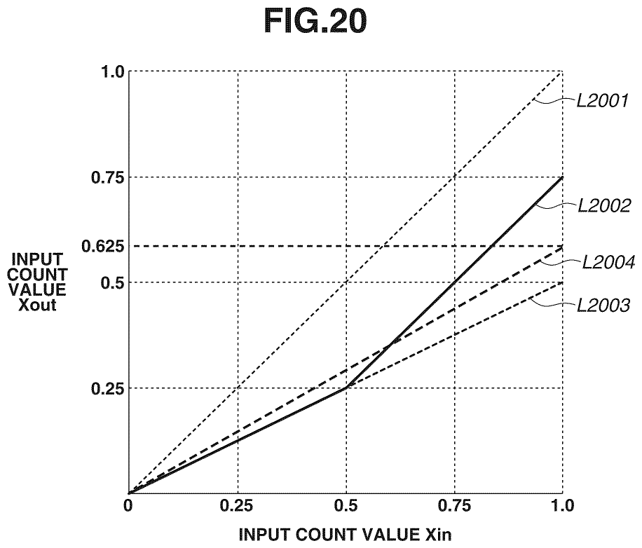

FIG. 20 is a diagram illustrating conversion formulae for predicting, from the density characteristic value and the target density value in which the output upper limit rank is the rank A, density characteristic values and target density values for the other ranks. A line L2001 represents a relationship between the input count value Xin obtained before conversion, i.e., when the output upper limit rank is the rank A, and the input count value Xout obtained by conversion. For example, a line L2002 represents an example of the relationship obtained by conversion when the output upper limit rank is the rank C, and, when the input count value Xin is 0 to 0.5, conversion of the input count value Xin is performed by the following formula (2), so that an input count value Xout obtained by conversion is acquired. Moreover, when the input count value Xin is 0.5 to 1.0, conversion of the input count value Xin is performed by the following formula (3):

$$Xout = Xin \times 0.5 , and \qquad ( 2 )$$

$$Xout = Xin - 0.25 . \qquad ( 3 )$$

A line L2003 represents an example of the relationship obtained by conversion when the output upper limit rank is the rank B and obtained by conversion for C, M, Y, and K2 inks when the output upper limit rank is the rank D, and conversion of the input count value Xin is performed by the following formula (4):

$$Xout = Xin \times 0.5 . \qquad ( 4 )$$

A line L2004 represents an example of the relationship obtained by conversion for K1 ink when the output upper limit rank is the rank D, and conversion of the input count value Xin is performed by the following formula (5):

$$Xout = Xin \times 0.6 25. \qquad ( 5 )$$

As described above, in step S1705 and step S1706 illustrated in FIG. 17, the CPU 20a performs conversion processing to estimate the density characteristic value and the target density value for each rank. The density characteristic value and the target density value estimated for each rank become recording density values associated with the respective applying amounts as illustrated in FIG. 9B described above. For example, in the case of K1 ink for the rank D, the maximum value of the applying amount (horizontal axis) is 125%.

Referring back to FIG. 17, in step S1707, the CPU 20a generates a color misregistration correction table based on the density characteristic values and the target density values for the respective ranks. With regard to the rank A, the CPU 20a generates a color misregistration correction table based on a density characteristic value which is the actual measured value and a target density value stored in the ROM 20c, and, with regard to ranks other than the rank A, the CPU 20a generates a color misregistration correction table based on the density characteristic value and target density value obtained by conversion.

Furthermore, the black color boundary region and the black white boundary region are small in area ratio and, therefore, can be configured not to be targeted for color misregistration correction. Color misregistration correction can be performed independently for every region.

As explained in the foregoing description, estimating the density characteristic value and the target density value even without recording a test pattern for color calibration for every recording mode enables generating a color misregistration correction table.

### <Switching Processing for Correction Type for Maximum Gradation Value of Black>

Next, a method of allocating correction types depending on respective conditions is described. In the case of a recording head in which the amount of ink per ink droplet (the discharge amount) is large, correction is performed by a color misregistration correction processing unit in such a way as to reduce the applying amount, i.e., the number of dots. In a case where a recording image is a line or character, reducing the number of dots may result in a line being broken without becoming continuous.

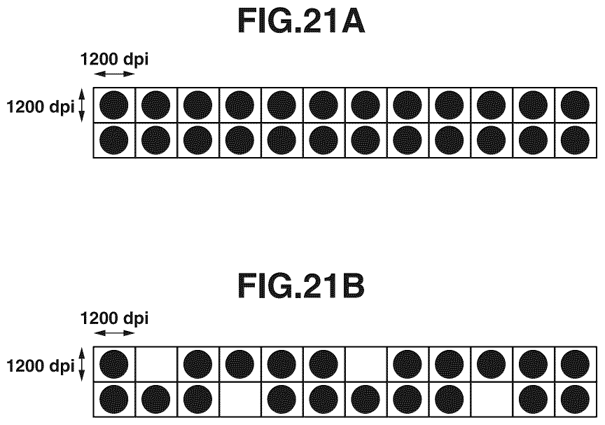

FIGS. 21A and 21B are diagrams illustrating an example of recording a line with use of K1 ink in each pixel of 1,200 dpi×1,200 dpi. FIG. 21A illustrates a state in which the applying amount of K1 ink is 100% and color misregistration correction processing has not been performed. Dots of K1 ink are applied to all of the pixels, so that a line is not broken. On the other hand, FIG. 21B illustrates a state in which correction has been performed by color misregistration correction processing in such a way as to reduce the applying amount. Dots of K1 ink are not applied to all of the pixels, so that a line is broken.

Against an issue in which a line or character is broken in the above-mentioned manner, it is desirable to prevent the number of dots from being reduced by color misregistration correction processing. Particularly, an image used for line drawing, such as a line or character, is in many cases recorded at the maximum gradation (maximum density) of black, and, therefore, it is desirable not to perform color misregistration correction processing on such an image at the maximum gradation value. On the other hand, with respect to a photograph or an image used for illustration, it is desirable to give priority to matching colors and, thus, perform color misregistration correction processing even in the case of the maximum gradation value. Moreover, if black data is reduced by color misregistration correction processing, all of the surrounding pixels become not black pixels, so that it becomes impossible to correctly determine a black inner region in the K distribution thinning processing. Therefore, it is desirable not to perform color misregistration correction processing on the maximum gradation value with respect to a recording mode including a parameter set in which distribution thinning masks for the respective regions are different due to the K distribution thinning processing being performed. Accordingly, in the present exemplary embodiment, whether to perform color misregistration correction processing on the maximum gradation value is switched depending on recording modes.

Specifically, with respect to the points D101 to D109 illustrated in FIG. 9B, the CPU 20a searches for the same applying amount as that for the density of the target and, while causing only the point D110 corresponding to the maximum applying amount not to be searched for, performs the following processing.

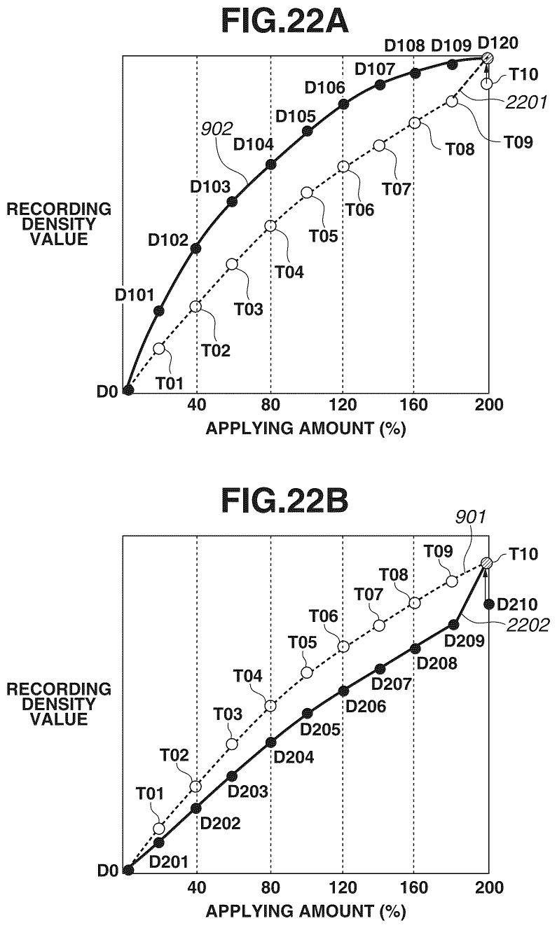

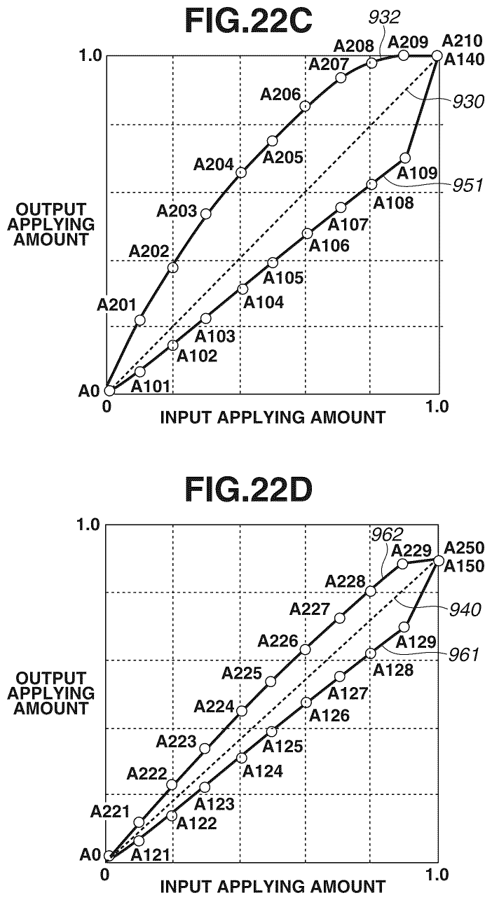

FIGS. 22A, 22B, 22C, and 22D are diagrams used to explain a generation method for a color misregistration correction table in the case of not performing color misregistration correction on the maximum applying amount. FIG. 22A illustrates an example of the case of “density characteristic value”> “target density value”. In this case, the CPU 20a replaces the recording density value at the maximum gradation of the target density value with the recording density value at the maximum gradation of the density characteristic value. In the case of the recording density value at the point D120>the recording density value at the point T10, the CPU 20a assigns the recording density value at the point D120 to the recording density value at the point T10. In other words, the CPU 20a assigns the density characteristic value to the target density value. The density curve of the target density value becomes values represented by a line 2201.

FIG. 22B illustrates an example of the case of “density characteristic value”≤“target density value”. In this case, the CPU 20a replaces the recording density value at the maximum gradation of the density characteristic value with the recording density value at the maximum gradation of the target density value. In the case of the recording density value at the point D210≤ the recording density value at the point T10, the CPU 20a assigns the recording density value at the point T10 to the recording density value at the point D210. In other words, the CPU 20a assigns the target density value to the density characteristic value. The density curve of the density characteristic value becomes values represented by a line 2202.

FIG. 22C illustrates a color misregistration correction table to be generated. A solid line 951 represents a color misregistration correction table in which, at the point A140 indicating the maximum applying amount for the actual machine A, the output applying amount is equal to the input applying amount.

FIG. 22D illustrates a color misregistration correction table to be generated in a case where there is a number-of-applications surplus illustrated in FIG. 9E. A solid line 961 represents a color misregistration correction table in which, at the point A150 indicating the maximum applying amount for the actual machine A, the output applying amount is equal to the input applying amount. A solid line 962 represents a color misregistration correction table in which, at the point A250 indicating the maximum applying amount for the actual machine B, the output applying amount is equal to the input applying amount.

The color misregistration correction tables described with reference to FIGS. 22A to 22D are referred to as a “correction type A”, and the color misregistration correction tables described with reference to FIGS. 9A to 9E and FIGS. 18 to 20 are referred to as a “correction type B”. With regard to the correction type A, the correction amount for the input applying amount at the maximum gradation is “0”. With regard to the correction type B, the correction amount for the input applying amount at the maximum gradation is not “0”. Furthermore, in a case where the density characteristic value of the recording head concerned is equal to the target density value, since the correction amount becomes “0” even with regard to the correction type B, the present exemplary embodiment is not limited to this.

Furthermore, while, in the present exemplary embodiment, a color misregistration correction table in which the correction amount is set “0” with respect to the maximum gradation value of black representing a pure black pixel is generated, a case where the correction amount is set “0” is not limited to only the case of the maximum gradation value. The correction amount for a range of gradation higher than or equal to a predetermined gradation including the maximum gradation can be set “0”, and the correction amount can be set “0” with respect to a pixel indicating a specific color. The specific color is not limited to achromatic color including black but can be chromatic color, and a configuration which gives to the specific color an attribute for setting the correction amount to “0” can be employed.

### <Correction Type Setting Processing for Color Misregistration Correction Table>

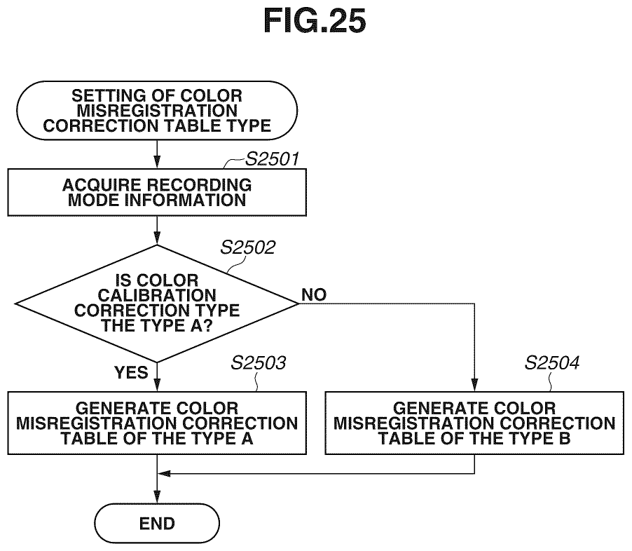

FIG. 25 is a flowchart of processing for setting the correction type of a color misregistration correction table to be generated. In step S2501, the CPU 20a acquires recording mode information for use in recording an image. In step S2502, the CPU 20a determines whether the color calibration correction type in the recording mode information table is the type A. If it is determined that the color calibration correction type is the type A (YES in step S2502), then in step S2503, the CPU 20a generates a color misregistration correction table of the type A, and, if it is determined that the color calibration correction type is not the type A (NO in step S2502), then in step S2504, the CPU 20a generates a color misregistration correction table of the type B. The reason for this is described as follows.

Referring to the recording mode information table illustrated in FIG. 10, with regard to the recording modes 1 and 4 to 6, the K distribution thinning processing parameter is the set 1 and the correction type of the color misregistration correction table is the type B. With regard to the recording modes 2 and 3, the K distribution thinning processing parameter is the set 2 and the correction type of the color misregistration correction table is the type A.

Since the above-mentioned K region determination processing performs determination based on whether the attribute of a pixel concerned is a pure black pixel, if the maximum gradation value included in K data is reduced by the color misregistration correction processing, the K region determination processing becomes unable to be correctly performed.

With regard to parameters of the set 2, thinning masks for the respective regions in the K distribution thinning processing are different. Therefore, unless the correction amount for the maximum gradation value of K data is “0”, the K region determination processing is not correctly performed. Accordingly, with respect to the recording mode which includes parameters of the set 2, a color misregistration correction table the correction type of which is the type A is generated.

On the other hand, with regard to the parameters of the set 1, thinning masks for the respective regions in the K distribution thinning processing are all the same. Therefore, regardless of how much the correction amount for the maximum gradation value of K data is, there is no influence on a result of the K region determination processing. Accordingly, with respect to the recording mode which includes parameters of the set 1, a color misregistration correction table the correction type of which is the type B is generated.

Furthermore, with respect to a recording mode for which the K distribution thinning processing is not performed, such as a recording mode in which recording is performed with only K2 ink, the term “none” is specified in the recording mode information table illustrated in FIG. 10.

Furthermore, the type A is a color misregistration correction table for the recording mode for use in recording line drawing and characters, and the type B is a color misregistration correction table for the recording mode for use in recording photographs and illustrations. Furthermore, the correction type can be set for every ink color, or can be set depending on images.

While, in the above-mentioned example, a method of generating a color misregistration correction table from density characteristic values and target density values of each actual machine has been described, a method of preliminarily retaining a plurality of color misregistration correction tables and performing selection from among the plurality of color misregistration correction tables can also be employed.

Examples of the method for selection include a method of using density rank information about a recording head. The method determines, at the time of manufacturing of recording heads, the discharge amounts or discharge port sizes of the respective recording heads and, based on a relationship shown in Table 2, preliminarily retains density rank information associated with density characteristics in a memory of each recording head. The recording apparatus selects a color misregistration correction table depending on the density rank information retained in the recording head, and thus performs color misregistration correction processing. The discharge amount shown in Table 2 is a discharge amount ratio of the recording head concerned to the discharge amount of a reference recording head.

TABLE 2

| Discharge amount | Density characteristic | Density rank |
|---|---|---|
| +15%- | very dense | 7 |
| +10%-+15% | dense | 6 |
| +5%-+10% | slightly dense | 5 |
| ±5% | standard | 4 |
| −5%-−10% | slightly thin | 3 |
| −10%-−15% | thin | 2 |
| -−15% | very thin | 1 |

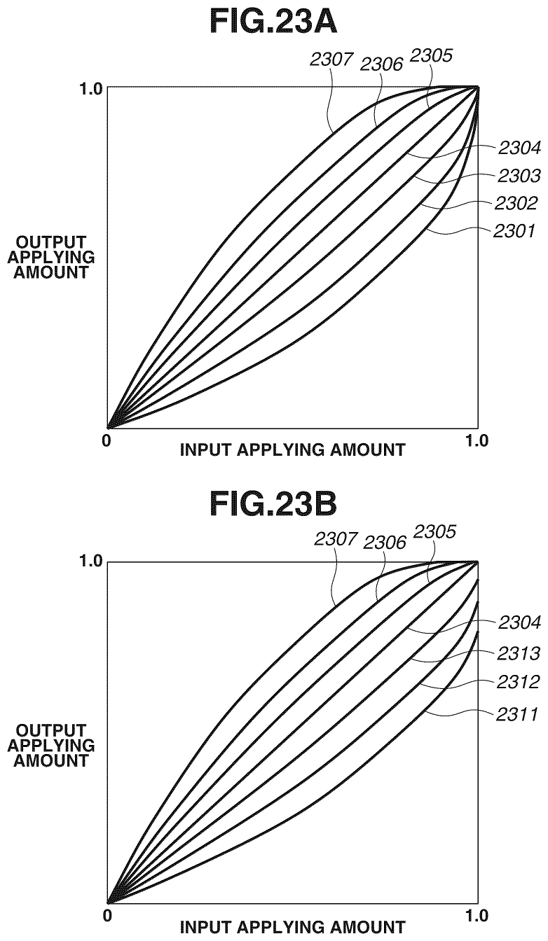

FIGS. 23A and 23B are diagrams illustrating a selection method for a color misregistration correction table in a case where there is no number-of-applications surplus. FIG. 23A illustrates color misregistration correction tables associated with respective density ranks in the case of the correction type A. In the case of the density rank 4, which corresponds to the standard density, a color misregistration correction table 2304 in which the input applying amount and the output applying amount are equal to each other is selected. Thus, the correction amount is “0”.

In the case of the density rank 1, which corresponds to a recording head which is smaller in discharge amount than a recording head for the standard density, a color misregistration correction table 2307 is selected. Similarly, in the case of the density rank 2, a color misregistration correction table 2306 is selected, and, in the case of the density rank 3, a color misregistration correction table 2305 is selected.

In the case of the density rank 5, which corresponds to a recording head which is larger in discharge amount than a recording head for the standard density, a color misregistration correction table 2303 is selected. Similarly, in the case of the density rank 6, a color misregistration correction table 2302 is selected, and, in the case of the density rank 7, a color misregistration correction table 2301 is selected.

FIG. 23B illustrates color misregistration correction tables associated with respective density ranks in the case of the correction type B. In the case of the density rank 5 for a recording head, a color misregistration correction table 2313 is selected, in the case of the density rank 6, a color misregistration correction table 2312 is selected, and, in the case of the density rank 7, a color misregistration correction table 2311 is selected.

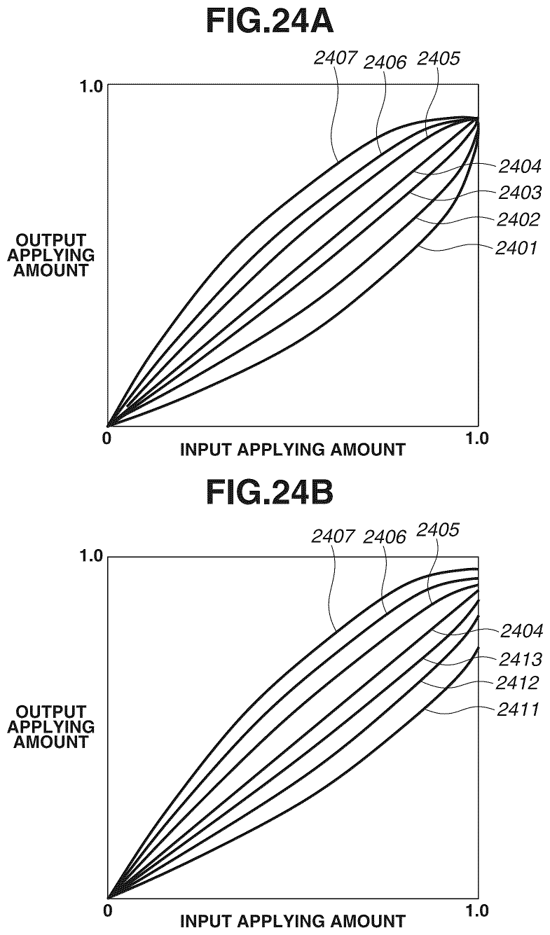

FIGS. 24A and 24B are diagrams illustrating a selection method for a color misregistration correction table in a case where there is a number-of-applications surplus. FIG. 24A illustrates color misregistration correction tables associated with respective density ranks in the case of the correction type A.

In the case of the density rank 4, a color misregistration correction table 2404 in which the input applying amount and the output applying amount are equal to each other and the correction amount is “0” is selected.

In the case of the density rank 1, which corresponds to a recording head which is smaller in discharge amount than a recording head for the standard density, a color misregistration correction table 2407 is selected. Similarly, in the case of the density rank 2, a color misregistration correction table 2406 is selected, and, in the case of the density rank 3, a color misregistration correction table 2405 is selected.

In the case of the density rank 5, which corresponds to a recording head which is larger in discharge amount than a recording head for the standard density, a color misregistration correction table 2403 is selected. Similarly, in the case of the density rank 6, a color misregistration correction table 2402 is selected, and, in the case of the density rank 7, a color misregistration correction table 2401 is selected.

FIG. 24B is a diagram illustrating color misregistration correction tables associated with respective density ranks in the case of the correction type B. In the case of the density rank 5, a color misregistration correction table 2413 is selected. In the case of the density rank 6, a color misregistration correction table 2412 is selected, and, in the case of the density rank 7, a color misregistration correction table 2411 is selected.

As just described above, according to the present exemplary embodiment, it becomes possible to perform color misregistration correction while preventing or reducing a decrease in quality, depending on uses of images to be recorded.

An aspect of the present disclosure enables providing an image processing apparatus capable of recording an image desired by the user by performing color calibration depending on recording modes.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors, circuitry, or combinations thereof (e.g., central processing unit (CPU), micro processing unit (MPU), or the like), and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priorities from Japanese Patent Applications No. 2023-060489 filed Apr. 3, 2023, and No. 2024-040551 filed Mar. 14, 2024, which are hereby incorporated by reference herein in their entirety.

What is claimed is:

1. An image processing apparatus comprising:
an input unit configured to receive an instruction indicating which recording mode of a plurality of recording modes to use to record an image;
a correction unit configured to perform correction processing for image data including pixel values for use in applying ink onto a recording medium with a recording unit;
an acquisition unit configured to acquire a density characteristic value by measuring a patch pattern recorded by the recording unit; and
a retention unit configured to retain a target density value associated with an input gradation value,
wherein, in a case where the recording mode indicated by the received instruction is a first recording mode and a density characteristic value for a patch pattern in an input gradation value greater than or equal to a predetermined gradation is higher than the target density value associated with an input gradation value, in the correction processing, a correction value for an input gradation value greater than or equal to the predetermined gradation is not 0, and
wherein, in a case where the recording mode indicated by the received instruction is a second recording mode and a density characteristic value for a patch pattern in an input gradation value greater than or equal to the predetermined gradation is higher than the target density value associated with an input gradation value, in the correction processing, a correction value for an input gradation value greater than or equal to the predetermined gradation is 0.

2. The image processing apparatus according to claim 1,
wherein, in a case where the recording mode indicated by the received instruction is the first recording mode, a density characteristic value for a patch pattern in an input gradation value greater than or equal to the predetermined gradation is lower than the target density value associated with an input gradation value, and an output value corresponding to a maximum value of an input gradation value is smaller than a maximum value of an output gradation value, in the correction processing, a correction value for an input gradation value greater than or equal to the predetermined gradation is not 0, and
wherein, in a case where the recording mode indicated by the received instruction is the first recording mode, a density characteristic value for a patch pattern in an input gradation value greater than or equal to the predetermined gradation is lower than the target density value associated with an input gradation value, and an output value corresponding to a maximum value of an input gradation value is equal to a maximum value of an output gradation value, in the correction processing, a correction value for an input gradation value greater than or equal to the predetermined gradation is 0.

3. The image processing apparatus according to claim 1, wherein, in a case where the recording mode indicated by the received instruction is the second recording mode and a density characteristic value for a patch pattern in an input gradation value greater than or equal to the predetermined gradation is lower than the target density value associated with an input gradation value, in the correction processing, a correction value for an input gradation value greater than or equal to the predetermined gradation is 0.

4. The image processing apparatus according to claim 1, wherein the first recording mode is a recording mode for use in recording photographs.

5. The image processing apparatus according to claim 1, wherein the second recording mode is a recording mode for use in recording line drawing.

6. The image processing apparatus according to claim 1, wherein an input gradation value greater than or equal to the predetermined gradation is a maximum gradation value.

7. The image processing apparatus according to claim 1, further comprising:
the recording unit; and
a control unit configured to control a recording operation to be performed by the recording unit.

8. An image processing method comprising:
receiving an instruction indicating which recording mode of a plurality of recording modes to use to record an image;
performing correction processing for image data including pixel values for use in applying ink onto a recording medium with a recording unit; and
acquiring a density characteristic value by measuring a patch pattern recorded by the recording unit,
wherein, in a case where the recording mode indicated by the received instruction is a first recording mode and a density characteristic value for a patch pattern in an input gradation value greater than or equal to a predetermined gradation is higher than the target density value associated with an input gradation value, in the correction processing, a correction value for an input gradation value greater than or equal to the predetermined gradation is not 0, and
wherein, in a case where the recording mode indicated by the received instruction is a second recording mode and a density characteristic value for a patch pattern in an input gradation value greater than or equal to the predetermined gradation is higher than the target density value associated with an input gradation value, in the correction processing, a correction value for an input gradation value greater than or equal to the predetermined gradation is 0.

9. A non-transitory computer-readable storage medium storing computer-executable instructions that, when executed by a computer, cause the computer to perform an image processing method comprising:
receiving an instruction indicating which recording mode of a plurality of recording modes to use to record an image;
performing correction processing for image data including pixel values for use in applying ink onto a recording medium with a recording unit; and
acquiring a density characteristic value by measuring a patch pattern recorded by the recording unit,
wherein, in a case where the recording mode indicated by the received instruction is a first recording mode and a density characteristic value for a patch pattern in an input gradation value greater than or equal to a predetermined gradation is higher than the target density value associated with an input gradation value, in the correction processing, a correction value for an input gradation value greater than or equal to the predetermined gradation is not 0, and
wherein, in a case where the recording mode indicated by the received instruction is a second recording mode and a density characteristic value for a patch pattern in an input gradation value greater than or equal to the predetermined gradation is higher than the target density value associated with an input gradation value, in the correction processing, a correction value for an input gradation value greater than or equal to the predetermined gradation is 0.

10. An image processing apparatus comprising:
a memory configured to retain a plurality of types of applying amount information indicating an applying amount of ink for at least one input gradation value in association with a plurality of recording modes;
an input unit configured to receive an instruction indicating which recording mode of the plurality of recording modes to use to record an image; and
a generation unit configured to generate a color misregistration correction table for the recording mode indicated by the received instruction based on target density values for a plurality of ink applying amounts in a predetermined recording mode of the plurality of recording modes and density characteristic values obtained by measuring patch patterns associated with the plurality of ink applying amounts recorded in the predetermined recording mode,
wherein, in a case where the recording mode indicated by the received instruction is not the predetermined recording mode, the generation unit generate a color misregistration correction table for the recording mode indicated by the received instruction based on the applying amount information, the target density values, and the density characteristic values associated with the recording mode indicated by the received instruction.

11. The image processing apparatus according to claim 10, wherein, in a case where the recording mode indicated by the received instruction is not the predetermined recording mode, the generation unit converts the target density values and the density characteristic values based on the applying amount information associated with the recording mode indicated by the received instruction, and generates a color misregistration correction table for the recording mode indicated by the received instruction based on values obtained by converting the target density values and the density characteristic values.

12. The image processing apparatus according to claim 10, wherein, in a case where a value of an ink applying amount for an input gradation value in applying amount information in the recording mode indicated by the received instruction is equal to an amount of an ink applying amount for an input gradation value in applying amount information in the predetermined recording mode, the generation unit generates a color misregistration correction table for the recording mode indicated by the received instruction with use of the target density values and the density characteristic values.

13. The image processing apparatus according to claim 10,
wherein the memory retains a recording mode information table in which output upper limit ranks are associated with the respective plurality of recording modes and a rank table in which the applying amount information is associated with the output upper limit ranks, and
wherein the generation unit acquires the output upper limit rank associated with the recording mode indicated by the received instruction from the recording mode information table, and generates a color misregistration correction table for the recording mode indicated by the received instruction based on applying amount information corresponding to the acquired output upper limit rank.

14. The image processing apparatus according to claim 10, wherein the memory retains, as the applying amount information, a plurality of ink applying amounts associated with a respective plurality of input gradation values.

15. The image processing apparatus according to claim 10, wherein the applying amount information is a value indicating a number of ink droplets per unit area with respect to an input gradation value.

16. The image processing apparatus according to claim 10, wherein the applying amount information retained by the memory includes applying amount information including values in which an applying amount linearly increases at a constant inclination with respect to an input gradation value and applying amount information including values in which an inclination at which an applying amount increases with respect to an input gradation value is not constant and the applying amount does not linearly increase.

17. The image processing apparatus according to claim 10, further comprising:
a recording unit configured to record an image by applying ink onto a recording medium; and
a control unit configured to control recording of an image to be performed by the recording unit.

18. An image processing method comprising:
receiving an instruction indicating which recording mode of a plurality of recording modes to use to record an image; and
generating a color misregistration correction table for the recording mode indicated by the received instruction based on target density values for a plurality of ink applying amounts in a predetermined recording mode of the plurality of recording modes and density characteristic values obtained by measuring patch patterns associated with the plurality of ink applying amounts recorded in the predetermined recording mode,
wherein, in a case where the recording mode indicated by the received instruction is not the predetermined recording mode, applying amount information indicating an ink applying amount for at least one input gradation value associated with the recording mode indicated by the received instruction is acquired, and
wherein a color misregistration correction table for the recording mode indicated by the received instruction is generated based on the acquired applying amount information, the target density values, and the density characteristic values.

19. A non-transitory computer-readable storage medium storing computer-executable instructions that, when executed by a computer, cause the computer to perform an image processing method comprising:
receiving an instruction indicating which recording mode of a plurality of recording modes to use to record an image; and
generating a color misregistration correction table for the recording mode indicated by the received instruction based on target density values for a plurality of ink applying amounts in a predetermined recording mode of the plurality of recording modes and density characteristic values obtained by measuring patch patterns associated with the plurality of ink applying amounts recorded in the predetermined recording mode,
wherein, in a case where the recording mode indicated by the received instruction is not the predetermined recording mode, applying amount information indicating an ink applying amount for at least one input gradation value associated with the recording mode indicated by the received instruction is acquired, and
wherein a color misregistration correction table for the recording mode indicated by the received instruction is generated based on the acquired applying amount information, the target density values, and the density characteristic values.
